(19) United States
(12) Patent Application Publication
(10) Pub. No.: US 2015/0242825 A1
(43) Pub. Date: Aug. 27, 2015

(54) GENERATION, STORAGE, AND VALIDATION OF ENCRYPTED ELECTRONIC CURRENCY

(71) Applicant: Peter Burton Mills, Los Altos, CA (US)

(72) Inventor: Peter Burton Mills, Los Altos, CA (US)

(21) Appl. No.: 14/628,166

(22) Filed: Feb. 20, 2015

Related U.S. Application Data
(60) Provisional application No. 61/943,661, filed on Feb. 24, 2014.

(51) Int. Cl. G06Q 20/06

(52) U.S. Cl. CPC G06Q 20/0655; G06Q 2220/00

(57) ABSTRACT

A system and method for generating and validating encrypted electronic currency is disclosed. A server system stores one or more encrypted electronic currency records in a database. The server system then receives one or more encrypted electronic currency units from a merchant system. For each respective encrypted electronic currency unit of the one or more encrypted electronic currency units, the server system accesses a respective encrypted electronic currency record associated with the respective encrypted electronic currency unit. The server system determines whether the respective encrypted electronic currency unit is valid. In accordance with a determination that the respective encrypted electronic currency unit is valid, the server system updates the respective encrypted electronic currency record to indicate that the encrypted electronic currency unit now invalid. In accordance with a determination that each encrypted electronic currency unit is valid, the server system transmits a currency validation notification to the merchant system.

### CROSS REFERENCE TO RELATED APPLICATIONS

This claims priority to provisional U.S. application Ser. No. 61/943,661, filed Feb. 24, 2014, which is incorporated by reference herein in its entirety.

### TECHNICAL FIELD

The disclosed example embodiments relate generally to the field of electronic devices and, in particular, to generate, store, and validate encrypted electronic currency using electronic devices such as laptop computers, mobile phones, tablet computers and other such devices.

### BACKGROUND

The rise of the computer age has resulted in dramatic increases in the availability and usefulness of electronic devices and communication across computer networks. Thus, as the cost of electronics and networks drop, many services that were previously provided in person are now provided remotely over the Internet or via a personal electronic device. For example, entertainment has increasingly shifted to the online space with companies streaming television (TV) shows and movies to consumers at home or away from home on a personal electronic device such as a smartphone or tablet computer. Similarly, electronic mail (e-mail) has reduced the need for letters to be physically delivered. Instead, messages can be sent over networked systems almost instantly. Online social networking sites allow members to build and maintain personal and business relationships in a much more comprehensive and manageable manner than meeting face to face or writing and mailing traditional letters.

The financial sector is one important service area revolutionized by the improved access to personal electronic devices and network based services. Increasingly, users are able to pay for goods online using credit card accounts, debit card accounts, or other online payment systems. Additionally, new currencies, such as crypto-currencies or math-based currencies have become available, allowing anonymous or near anonymous exchange of electronic funds.

However, the usefulness of the relatively new electronic financial services is limited because it is difficult to use them in situations in which cash is the most convenient method of payment. For example, some merchants do not take credit cards (due to the interchange fees, for example) or some transactions are for low amounts of money and the consumer prefers to complete them quickly and simply.

### DESCRIPTION OF THE DRAWINGS

Some example embodiments are illustrated by way of example and not limitation in the FIGS. of the accompanying drawings, in which:

FIG. 1 is a network diagram depicting a client-server environment, in accordance with an example embodiment, that includes various functional components.

FIG. 2 is a network diagram depicting a client-server environment, in accordance with an example embodiment, that includes various functional components.

FIG. 3 is a block diagram illustrating a client system, in accordance with some example embodiments.

FIG. 4 is a block diagram further illustrating the server system, in accordance with some example embodiments.

FIGS. 5A and 5B are a block diagram of example data structures, in accordance with some example embodiments.

FIG. 6 is a flow diagram illustrating a method, in accordance with some example embodiments, for requesting encrypted electronic currency.

FIG. 7 is a flow diagram illustrating a method, in accordance with some example embodiments, for generating encrypted electronic currency.

FIG. 8 is a flow diagram illustrating a method, in accordance with some example embodiments, for processing and validating encrypted electronic currency for transactions.

FIG. 9 is a flow diagram illustrating a method, in some example embodiments, for depositing electronic funds as necessary.

FIG. 10 is a flow diagram illustrating a method, in accordance with some example embodiments, for cancelling and replacing encrypted electronic currency units stored in a lost or stolen or inoperable client system.

FIG. 11 is a flow diagram illustrating a method, in accordance with an example embodiment, for generating encrypted electronic currency based on a request from a client system.

FIG. 12 is a flow diagram illustrating a method, in accordance with some example embodiments, for requesting and validating encrypted electronic currency units from a server system (e.g., the server system of FIG. 1), in accordance with some example embodiments

FIG. 13 is a flow diagram illustrating a method, in accordance with some example embodiments, for validating encrypted electronic currency.

FIG. 14 is a flow diagram illustrating a method, in accordance with some example embodiments, for cancelling and replacing encrypted electronic currency stored in a lost or stolen or inoperable client system.

FIG. 15 is a block diagram illustrating an architecture of software, in accordance with an example embodiment.

FIG. 16 is a block diagram illustrating components of a machine, according to some example embodiments.

Like reference numerals refer to corresponding parts throughout the drawings.

### DETAILED DESCRIPTION

The present disclosure describes methods, systems, and computer program products for generating, storing, and validating encrypted electronic currency. In the following description, for purposes of explanation, numerous specific details are set forth to provide a thorough understanding of the various aspects of different embodiments. It will be evident, however, to one skilled in the art, that any particular embodiment may be practiced without all of the specific details and/or with variations permutations and combinations of the various features and elements described herein.

In some example embodiments, it is useful to have a digital analog to cash (e.g., cash is fast and easy to use for small purchases, cash provides privacy where the spender does not want to be tracked by a store, bank, or marketing organization, and cash allows transience, where the user crumples up and tosses out a receipt and the user does not want to reconcile such purchases on a bank or credit card statement) without any of the obvious drawbacks of cash (e.g., having to go to the bank to get it and having it stolen). To facilitate such a digital cash analog, a server system allows client systems (associated with users) to register with unique account information.

In some example embodiments, a user with a client system wants to purchase a good or a service from a merchant (e.g., a store). The user can buy such good or service by spending encrypted electronic currency stored on the user's electronic device. The client system can request to withdraw a certain amount of money from the user's bank account and store that money as encrypted electronic currency (e.g., digital representation of currency stored in a file or app on an electronic system) on the user's electronic device. Encrypted electronic currencies use powerful encryption techniques to prevent theft or fraud.

Once a server system receives a request for a certain amount of encrypted electronic currency, the server system uses the account information associated with the requesting client system to confirm that the client system is authorized to request that amount of currency from the bank account of a user associated with the client system. For example, client device A sends a request to the server system for fifty dollars of encrypted electronic currency. The server system then uses account information associated with the client system to determine whether the bank associated with the client system will authorize a fifty dollar withdrawal.

In some example embodiments, once an authorization is received, the server system generates one or more encrypted electronic currency units to meet the requested amount of currency. In some example embodiments, each unit of encrypted electronic currency (e.g., a digital coin) has a unique identifier (e.g., a serial number), a value (e.g., one cent, five dollars), a currency type (e.g., .United States Dollars (USD), Euros, Canadian dollars, and so on), and an encrypted identifier of the client system which requested the encrypted electronic currency units. In some example embodiments, once the encrypted electronic currency units have been generated, they are transmitted to the requesting client system for storage.

In some example embodiments, encrypted electronic currency units are of a fixed denomination and cannot be subdivided into lesser denominations. In some example embodiments, the server system also creates a record for each encrypted electronic currency unit created. The records are stored in a database at the server system. In addition to all of the information stored in the encrypted electronic currency unit itself, the encrypted electronic currency record also records whether each encrypted electronic currency unit is still valid (e.g., whether it has already been spent or otherwise used). When encrypted electronic currency units are initially stored the encrypted electronic currency records indicate that they are valid.

However, once the server system receives notice that a particular encrypted electronic currency unit has been used, the records associated with the particular encrypted electronic currency unit are updated to note that the encrypted electronic currency unit is no longer valid. Accordingly, a status of the encrypted currency unit may be changed to preclude any further use of the specific unit. In an example embodiment, the encrypted electronic currency unit can only be spent once, unlike a physical dollar for example, which can be spent many times as it passes from person to person to merchant.

In some example embodiments, the user with the client system can then enter a merchant's place of business and identify a good or service the user wishes to purchase. Using the client system, the user can connect with the merchant system (e.g., wirelessly) and transmit one or more encrypted electronic currency units to the merchant system to pay for the good or service.

The merchant system transfers the encrypted electronic currency information to the server system. The server system determines, based on records stored at the server system, whether the encrypted electronic currency units are valid. If so, the server system authorizes the transaction and the merchant exchanges the goods or services desired by the user associated with the client device for the encrypted electronic currency units. In some example embodiments, the server system will then transmit an equivalent amount of electronic funds (e.g., sovereign currency) to the merchant's bank account.

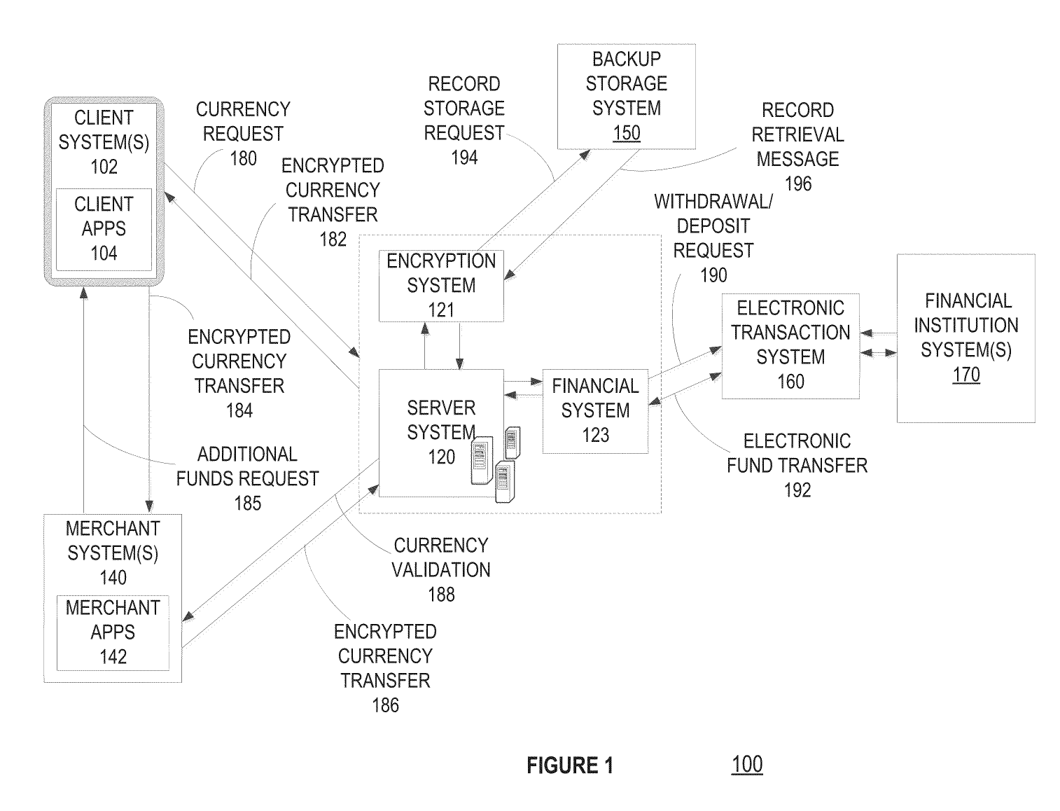

FIG. 1 is a network diagram depicting a client-server environment 100, in accordance with an example embodiment, that includes various functional components. In some example embodiments, client-server environment 100 includes one or more client system(s) 102, a server system 120, one or more merchant system(s) 140, a backup storage system 150, an electronic transaction system 160, and one or more financial institution system(s) 170. One or more communication networks interconnect these components. The communications network may be any of a variety of network types, including local area networks (LANs), wide area networks (WANs), wireless networks, wired networks, the Internet, personal area networks (PANs), or a combination of such networks. In some example embodiments, the various components are arranged such that the server system 120 acts as a cloud based system from the perspective of the client system 102.

The client system 102 is an electronic device such as a laptop computer, a personal computer (PC), a smartphone, a tablet computer, a wearable computing device, and so on. In some example embodiments, the client system 102 includes one or more client applications 104, which are executed by the client system 102. In some example embodiments, the client application(s) 104 includes one or more applications from a set consisting of search applications, communication applications, productivity applications, game applications, word processing applications, encryption and decryption applications, and any other useful applications. In some example embodiments, each of the one or more client systems 102 have one or more copies of an encrypted electronic currency application running at a given time.

The client system 102 communicates with the server system 120 to request encrypted electronic currency 180. In some example embodiments, the currency request 180 includes a number of data fields, including, but not limited to, a particular value (e.g., the amount of currency desired), the denominations of the encrypted electronic currency, the currency type (e.g., dollars, euros, and so on), and a unique identifier of the client system 102.

In some example embodiments, a single client system 102 is associated with more than one user. In this case, there are two instantiations of an encrypted electronic currency application on the single client system, or, alternatively, a single application with two separate login accounts available on the client system 120. Each user's encrypted electronic currency units and account information is stored separately and each user would only be able to access their own encrypted electronic currency units or account information through a validation system (e.g., using a PIN or password system).

In some example embodiments, in response to the currency request 180, the server system 120 sends a withdrawal request 190 through an electronic transaction system 160 to a financial institution system 170 associated with the user of the client system 102 (e.g., based on account information received from the client system 102 when the client system registers with the server system 120). In some example embodiments, the financial institution system 170 approves the withdrawal request 190 and creates an electronic fund transfer 192 through the electronic transaction system 160 to the financial system 123.

In some example embodiments, the server system 120 stores the received electronic funds in a financial system 123 (e.g., a conventional bank or an electronic bank) associated with the server system 120. The server system 120 then uses an encryption system 121 to generate one or more encrypted electronic currency units equal to the currency value requested by the client system 102. Each encrypted electronic currency unit includes a unique identifier, a denomination or value, a currency type, and unique information identifying the requesting client system 102. In some example embodiments, the encryption system 121 encrypts the unique information identifying the requesting client system 102 such that even the server system 120 cannot identify the particular encrypted electronic currency units that have been encrypted and transferred to the client system 102.

In some example embodiments, the server system 120 stores the generated data for each encrypted electronic currency unit as an encrypted electronic currency record in a database associated with the server system 120. In addition, each encrypted electronic currency record includes an indication whether the encrypted electronic currency unit it represents is still valid. For example, each record includes a validity field that is set to true when an encrypted electronic currency unit is created, and set to false once it has been used, spent, or transferred.

In some example embodiments, the server system 120 receives an encrypted currency transfer 186 from a merchant system 140. In some example embodiments, encrypted currency transfer 186 is initiated by an encrypted electronic currency application 142 on the merchant system 140. The encrypted currency transfer 186 is made after a client system 102 initiates an encrypted currency transfer 184 from the client system 102 to the merchant system 140 to pay for one or more goods or services. The merchant system 140 and merchant apps 142 cannot identify the sender of the encrypted electronic currency units because the unique identifier in the encrypted electronic currency units that incorporates the unique identifier of the client system 102 or unique identifier of the client apps 104 is encrypted and cannot be read by the merchant system 140 or the merchant apps 142.

The server system 120 analyzes each encrypted electronic currency unit it receives as part of the encrypted currency transfer 186 to determine a unique identifier (e.g. a serial number) for each encrypted electronic currency unit. Once a unique identifier value has been identified for each encrypted electronic currency unit, the server system 120 determines, for each encrypted electronic currency record associated with each unique identifier value, whether the encrypted electronic currency unit associated with the each unique identifier value is valid.

In accordance with a determination that every encrypted electronic currency unit in the encrypted currency transfer 184 are determined to be valid, the server system 120 sends a currency validation 188 to the merchant system 140 indicating that all of the encrypted electronic currency units are valid. If one or more of the encrypted electronic currency units are determined to be invalid (e.g., already used or not yet issued), the currency validation 188 message includes the amount of the encrypted electronic currency units that were found invalid. In some embodiments, the merchant system 140 then sends an additional funds request 185 to the client system 102. In other embodiments, the sales clerk may ask the user to send more encrypted electronic currency units, or the client system could scan a visual code such as a bar code or QR code displayed by the merchant system 140 or use some other communication method to request additional encrypted electronic currency units from the client system (e.g., client system 102 in FIG. 1).

In some example embodiments, the server system (e.g., server system 120 in FIG. 1) also backs up encrypted electronic currency records at a backup storage system 150. In some example embodiments, the backup storage system 150 is a trusted third party that is distinct from, but connected over a network, to the server system 120. In other example embodiments, the backup storage system 150 is formally associated with (e.g., owned by the owners of a server system 120) but located at a remote location from the server system 120.

In some example embodiments, when a client system 102 is lost or stolen or inoperable, the user associated with the client device would generally like to recover the encrypted electronic currency units stored at the client system 102. The client system 102 causes a record storage request 194 to be sent to the backup storage system 150. The backup storage system 150 is able to decrypt the encrypted client identifying information stored in each encrypted electronic currency record. In some example embodiments, this is because the backup storage system 150 stores private keys for each client system 102 associated with the server system 120, or the client system 102 sends its private key to the backup storage system 150 as part of its request to recover encrypted electronic currency units. In other example embodiments, the backup storage system 150 receives the encrypted electronic currency records in an unencrypted form and then encrypts them locally for storage.

A records retrieval message 196 includes a unique identifier for a specific client system 102 (e.g., the client system 102 that was lost or stolen or is inoperable). In some example embodiments, the backup storage system 150 generates a list of all encrypted electronic currency units that are associated with the unique identifier for a specific client system 102. The backup storage system 150 then transfers the list of encrypted electronic currency units to the server system 120. The server system 120 compares the encrypted electronic currency units sent from the backup storage system 150 to the list of encrypted electronic currency records maintained by the system server 120 to determine which of the encrypted electronic currency units are currently valid. For each valid encrypted electronic currency unit in the list of encrypted electronic currency records, the server system generates a new encrypted electronic currency unit of the same value, transfers the new encrypted electronic currency unit to the new requesting client system 102 (which has replaced the old client system 102), and marks the encrypted electronic currency record associated with the old encrypted electronic currency unit to no longer be valid.

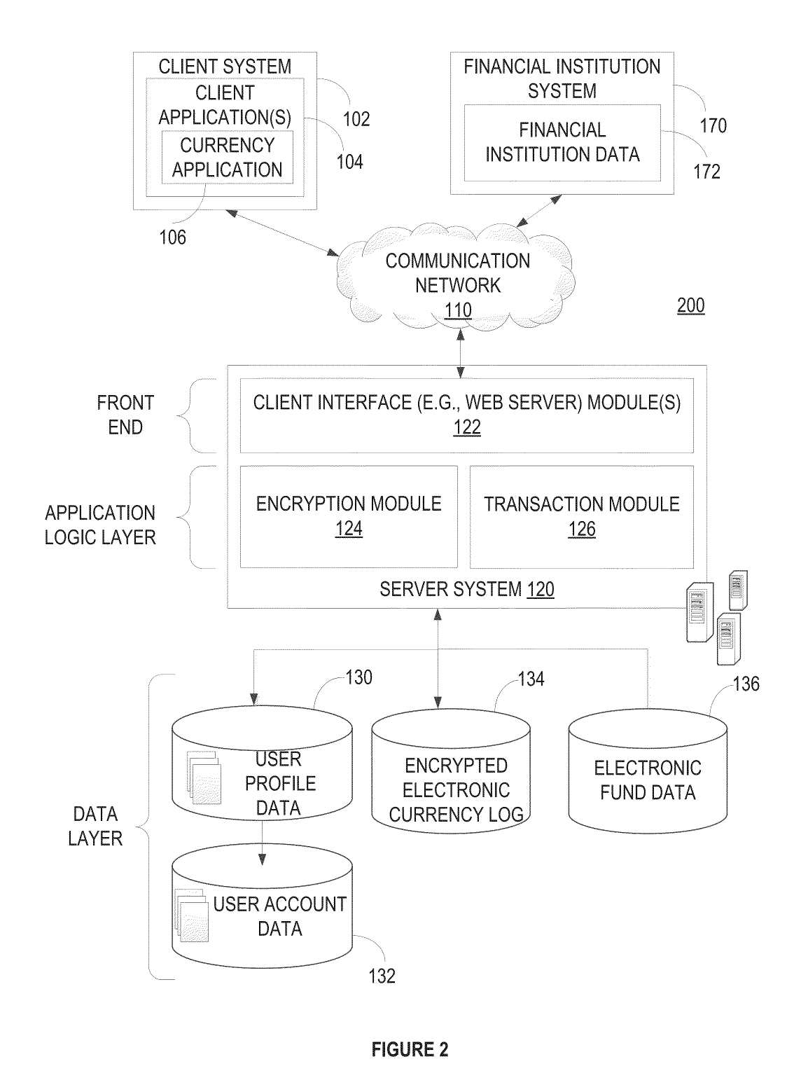

FIG. 2 is a network diagram depicting a client-server system environment 200 that includes various functional components of a server system 120, in accordance with some example embodiments. The client-server system environment 200 includes one or more client systems 102, a server system 120, and a financial institution system 170. One or more communication networks 110 interconnect these components. The communication networks 110 may be any of a variety of network types, including local area networks (LANs), wide area networks (WANs), wireless networks, wired networks, the Internet, personal area networks (PANs), or a combination of such networks.

In some example embodiments, a client system 102 is an electronic device, such as a personal computer (PC), a laptop, a smartphone, a tablet, a mobile phone, a wearable electronic device, or any other electronic device capable of communication with a communication network 110. The client system 102 includes one or more client applications 104, which are executed by the client system 102. In some example embodiments, the client application(s) 104 include one or more applications from a set consisting of search applications, communication applications, productivity applications, game applications, word processing applications, encryption and decryption applications, or any other useful applications. The client application(s) 104 include a currency application 106. The client system 102 uses the currency application 106 to communicate with the server system 120 and displays information received from the server system 120.

In some example embodiments, as shown in FIG. 2, the server system 120 is generally based on a three-tiered architecture, consisting of a front-end layer, an application logic layer, and a data layer. As is understood by skilled artisans in the relevant computer and Internet-related arts, each module or engine shown in FIG. 2 represents a set of executable software instructions and the corresponding hardware (e.g., memory and processor) for executing the instructions. To avoid unnecessary detail, various functional modules and engines that are not germane to conveying an understanding of the various embodiments have been omitted from FIG. 2. However, a skilled artisan will readily recognize that various additional functional modules and engines may be used with a server system 120, such as that illustrated in FIG. 1, to facilitate additional functionality that is not specifically described herein. Furthermore, the various functional modules and engines depicted in FIG. 2 may reside on a single server computer, or may be distributed across several server computers in various arrangements. Moreover, although the server system 120 is depicted in FIG. 2 as having a three-tiered architecture, the various embodiments are by no means limited to this architecture.

As shown in FIG. 2, the front-end layer consists of a user interface module 122, which receives requests over a communication network from one or more client systems 102, one or more merchant systems, and one or more financial institution systems 170.

As shown in FIG. 2, the data layer includes one or more databases, including databases for storing data for users of the server system 120, including user profile data 130, user account data 132, encrypted electronic currency log 134, and electronic fund data 136.

In some example embodiments, the user profile data 130 is a database (or other data structure) for storing data for one or more users associated with the server system 120. In some example embodiments, each user profile includes a unique identifier for a client system 102 associated with the user, user demographic information, personal information, such as his or her name, age (e.g., birth date), gender, interests, contact information, home town, address, educational background (e.g., schools, majors, etc.), current job title, job description, industry, employment history, skills, professional organizations, memberships with other online service systems, and so on.

In some example embodiments, the user account data 132 is included as part of the user profile data 130. In other example embodiments, the user account data 132 is stored separately. In some example embodiments, the user account data 132 includes information identifying one or more accounts at one or more financial institution systems 170 from which money can be withdrawn. In some example embodiments, the encrypted electronic currency log 134 includes one or more encrypted electronic currency records. In some example embodiments, a single log tracks all valid and invalid encrypted electronic currency units at the same time but has one or more backups. In contrast, some electronic currencies store records (e.g., a bitcoin block chain) that is maintained by thousands of computers.

In some example embodiments, the currency data 136 includes data describing electric funds 136 stored for each user of the server system 120. For example, if User A requests fifty USD, the server system 120 requests fifty USD in electronic funds from the appropriate financial institution system 170 and stores it in the electronic fund data 136. Additionally User A might also request to withdraw 100 Euros as encrypted electronic currency units. This request would be stored in the electronic fund data 136 as well.

In some example embodiments, the server system 120 provides a broad range of other applications and services that are useful one or more users.

In some example embodiments, the application logic layer includes various application server modules, which, in conjunction with the client interface module(s) 122, generate various user interfaces to receive input from and deliver output to a user. In some example embodiments, individual application modules are used to implement the functionality associated with various applications, services, and features of the server system 120. For instance, a messaging application, such as an email application, an instant messaging application, or some hybrid or variation of the two, or an alarm indicating a low balance of encrypted electronic currency units on the client device 102, may be implemented with one or more application modules.

In addition to the various application server modules, the application logic layer includes an encryption module 124 and a transaction module 126. In some example embodiments, the encryption module 124 is analogous to the encryption system 121 in FIG. 1. Similarly in some example embodiments, the transaction module 126 is analogous in function to the financial system 123 in FIG. 1. As illustrated in FIG. 2, in some example embodiments, the encryption module 124 and the transaction module 126 are implemented as modules that operate in conjunction with various application modules. For instance, any number of individual application modules can invoke the functionality of the encryption module 124 and the transaction module 126 to generate, store, and track encrypted electronic currency units. However, in various alternative embodiments, the encryption module 124 and the transaction module 126 may be implemented as their own application modules such that they operate as a stand-alone application.

Generally, the encryption module 124 generates encrypted electronic currency units in response to a request from a client system 102 for encrypted electronic currency units. In some example embodiments, the encryption module 124 determines the number and denomination of encrypted electronic currency units needed to respond to the currency request. The server system 120 then generates a unique identification value (e.g., a serial number) for each encrypted electronic currency unit needed.

In some example embodiments, the encryption module 124 builds the encrypted electronic currency units by populating the other fields needed for an encrypted electronic currency unit, including the denomination of each, the creation date, serial number, and so on. The encryption module 124 also encrypts user identification data using an appropriate encryption technique. For example, an asymmetrical encryption algorithm is used and the public key of the user is used to encrypt the user identification data. In this way, no one but the user (who holds their own private key) can decrypt the user identification data. In this way each user can verify that a particular encrypted electronic currency is associated with them, but no other party (including the server system 120) can identify the owner of a particular encrypted electronic currency unit by decrypting the user identification data.

The transaction module 126 initiates and responds to financial transactions requested by a client system 102 or initiated by the server system 120. In some example embodiments, the transaction module 126 receives a request for additional encrypted electronic currency. The transaction module 126 requests an equivalent amount of electronic currency from the appropriate financial institution system 170. If the request is approved, the electronic currency is withdrawn and stored in the electronic fund data 136, the encryption module 124 generates one or more encrypted electronic currency units which are then transferred to the client system 102.

In some example embodiments, the transaction module 126 receives encrypted electronic currency units 186 from a merchant system. The transaction module 126 uses unique identifier values in each encrypted electronic currency to identify a corresponding encrypted electronic currency record in the encrypted electronic currency log 134. Using the identified encrypted electronic currency record, the transaction module 126 determines if each encrypted electronic currency unit in the group of received encrypted electronic currency units is still valid. If so, the transaction module 126 sends a currency validation message 188 to the requesting merchant system. In accordance with a determination that at least one encrypted electronic currency unit in the group of received encrypted electronic currency units is invalid, the transaction module sends a message to the requesting merchant system indicating the value of the invalid encrypted electronic currency units, which the merchant system or sales clerk can use to request additional encrypted electronic currency units from the client system 102.

In accordance with a determination that all of the encrypted electronic currency units are valid, the transaction module 126 then transfers electronic funds from the electronic fund data 136 to a financial institution system 170 associated with the merchant system (e.g., account information received from the merchant system when they registered with the server system or installed the encrypted electronic currency application 142. In some example embodiments, each merchant system in the one or more merchant systems have an individual encrypted electronic currency application 142, and as such there are many such applications running at many different merchants simultaneously.

In some example embodiments, a encrypted electronic currency application for merchants can operate as a local application on merchant system 140, as client server app running on the merchant system and a remote server, or as cloud browser app running on a browser on the merchant system 140 and a web server.

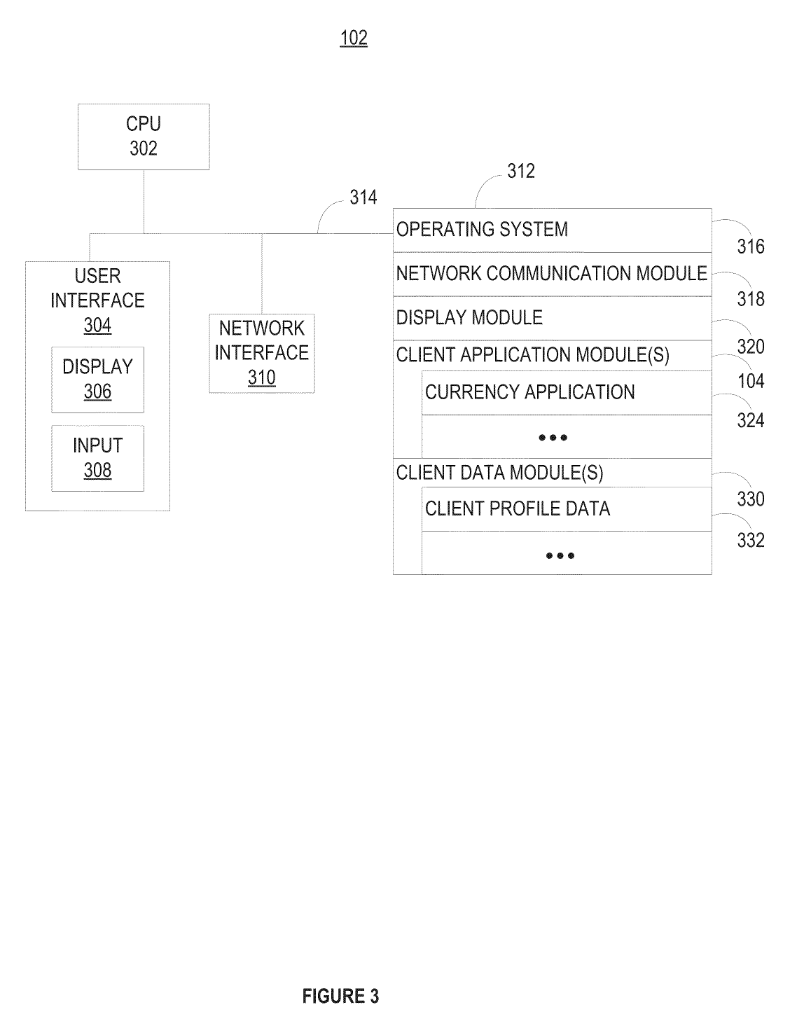

FIG. 3 is a block diagram illustrating a client system 102, in accordance with some example embodiments. The client system 102 typically includes one or more central processing units (CPUs) 302, one or more network interfaces 310, memory 312, and one or more communication buses 314 for interconnecting these components. The client system 102 includes a user interface 304. The user interface 304 includes a display 306 and optionally includes an input means such as a keyboard, mouse, a touch sensitive display, or other input buttons 308. Furthermore, some client systems 102 use a microphone and voice recognition and/or a camera system with image recognition software to supplement or replace the keyboard, touchscreen or other input mechanisms.

Memory 312 includes high-speed random access memory (RAM), such as dynamic random access memory (DRAM), static random access memory (SRAM), double data rate random access memory (DDR RAM), or other random access solid state memory devices; and may include non-volatile memory, such as one or more magnetic disk storage devices, optical disk storage devices, flash memory devices, or other non-volatile solid state storage devices. Memory 312 may optionally include one or more storage devices remotely located from the CPU(s) 302. Memory 312, or alternately, the non-volatile memory device(s) within memory 312, comprise(s) a non-transitory computer readable storage medium.

In some example embodiments, memory 312 or the computer-readable storage medium of memory 312 stores the following programs, modules, and data structures, or a subset thereof:
an operating system 316 that includes procedures for handling various basic system services and for performing hardware dependent tasks;
a network communication module 318 that is used for connecting the client system 102 to other computers via the one or more communication network interfaces 310 (wired or wireless or audio or optical or some other scheme) and one or more communication networks 110, such as the Internet, other WANs, LANs, metropolitan area networks (MANs), etc.;
a display module 320 for enabling the information generated by the operating system 316 and client applications 104 to be presented visually on the display 306;
one or more client applications 104 for handling various aspects of interacting with the server system 120 (FIG. 1), including but not limited to:
   a currency application 324 for sending requests for additional encrypted electronic currency to the server system (e.g., server system 120 in FIG. 1), receiving encrypted electronic currency from the server system 120, verifying the received encrypted electronic currency based on an encrypted client system 102 identifier, and transferring the encrypted electronic currency to a merchant system; and
a client data module(s) 330, for storing data relevant to the clients, including but not limited to:
   client profile 332 for storing data related to the client system 102, including but not limited to encrypted electronic currency received from the server system (e.g., server system 120 in FIG. 1) in response to a request for encrypted electronic currency.

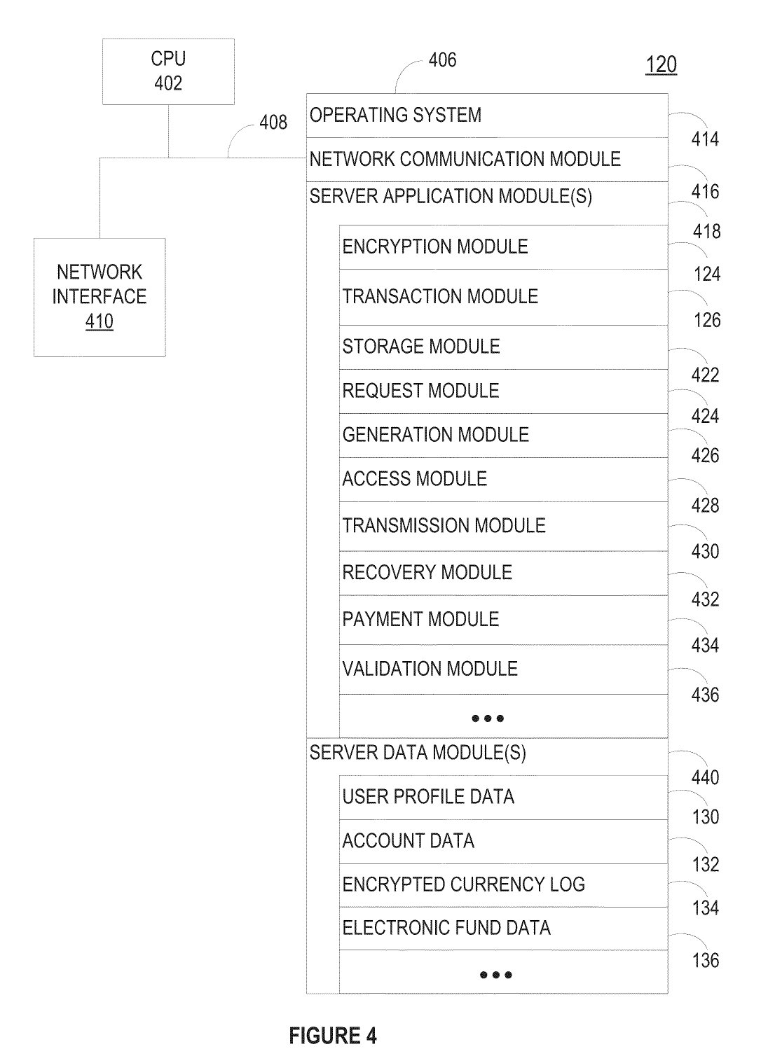

FIG. 4 is a block diagram further illustrating the server system 120, in accordance with some example embodiments. The server system 120 typically includes one or more CPUs 402, one or more network interfaces 410, memory 406, and one or more communication buses 408 for interconnecting these components. Memory 406 includes high-speed RAM, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 406 may optionally include one or more storage devices remotely located from the CPU(s) 402.

Memory 406, or alternately the non-volatile memory device(s) within memory 406, comprises a non-transitory computer readable storage medium. In some example embodiments, memory 406, or the computer readable storage medium of memory 46, stores the following programs, modules, and data structures, or a subset thereof:
an operating system 414 that includes procedures for handling various basic system services and for performing hardware dependent tasks;
a network communication module 416 that is used for connecting the server system 120 to other computers via the one or more communication network interfaces 410 (wired or wireless) and one or more communication networks 110, such as the Internet, other WANs, LANs, MANs, and so on;
one or more server application modules 418 for performing the services offered by server system 120, including but not limited to:
   an encryption module 124 for creating encrypted electronic currency units upon request including encrypting client system identifying information such that only authorized parties can determine which client system (e.g., system 120 in FIG. 1) is the owner of a particular encrypted electronic currency;
   a transaction module 126 for receiving encrypted electronic currency requests, withdrawing and depositing electronic funds from one or more financial institution systems (e.g., servers 170 in FIG. 2), and transmitting currency validations of encrypted electronic currency units as necessary;
   a storage module 422 for storing data encrypted electronic currency records associated with generated and issued encrypted electronic currency units, each record including one unique identification value matching the unique identification of an encrypted electronic currency unit;
   a request module 424 for sending a withdrawal request to a financial institution system (e.g., system 170 in FIG. 2) for electronic funds equal to the value requested in an encrypted electronic currency request received from a client system (e.g., system 102 in FIG. 1);
   a generation module 426 for creating a new encrypted electronic currency unit upon request from a client system (e.g., system 120 in FIG. 1);
   an access module 428 for accessing one or more encrypted electronic currency records stored in the encrypted electronic currency log 134 based on one or more unique identification values;
   a transmission module 430 for transmitting encrypted electronic currency units to a requesting client system (e.g., client system 102 in FIG. 1) or a currency validation message to a merchant system (e.g., system 140 in FIG. 1);
   a recovery module 432 for recovering lost, stolen, or inoperable encrypted electronic currency units;
   a payment module 434 for transmitting electronic funds to one or more financial institution systems (e.g., servers 170 in FIG. 2); and
   a validation module 436 for determining, based on the unique identification number associated with a received encrypted electronic currency unit, whether the received encrypted electronic currency unit is still valid; and
server data module(s) 440, holding data related to server system 120, including but not limited to:
   user profile data 130 for storing profile data related to users registered with the server system 120;
   account data 132, including financial account information for one or more users of the server system 120;
   encrypted electronic currency log 134 including a plurality of encrypted electronic currency records, each encrypted electronic currency records associated with a particular encrypted electronic currency unit; and
   electronic fund data 136 including information describing all of the electronic funds stored at the server system 120.

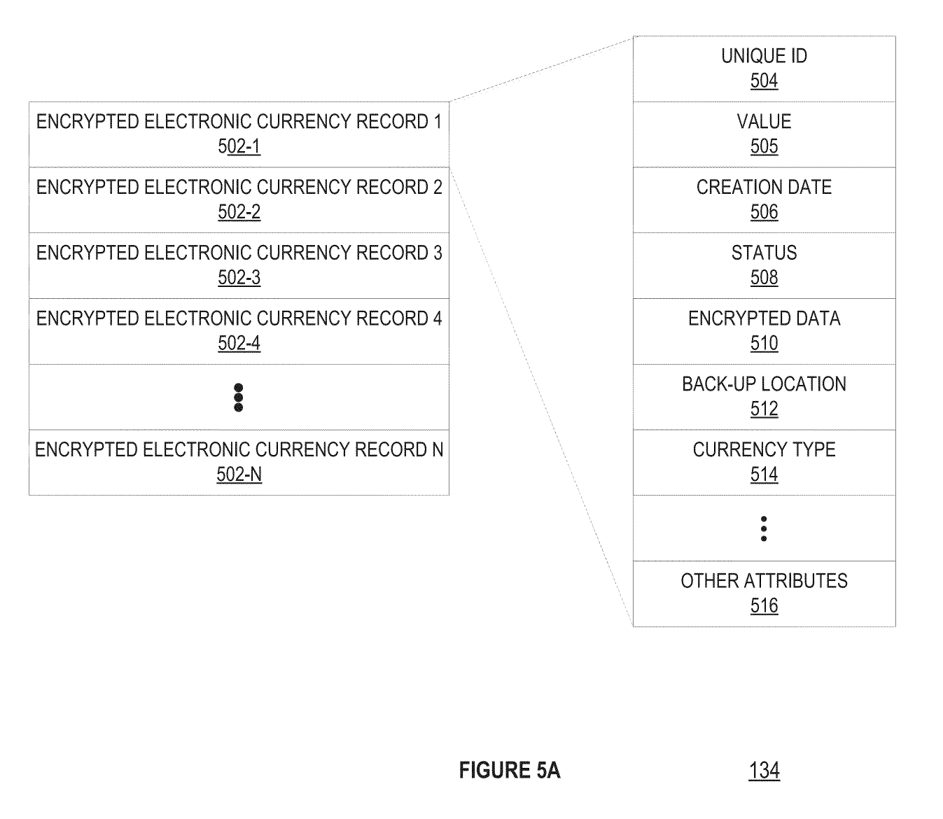

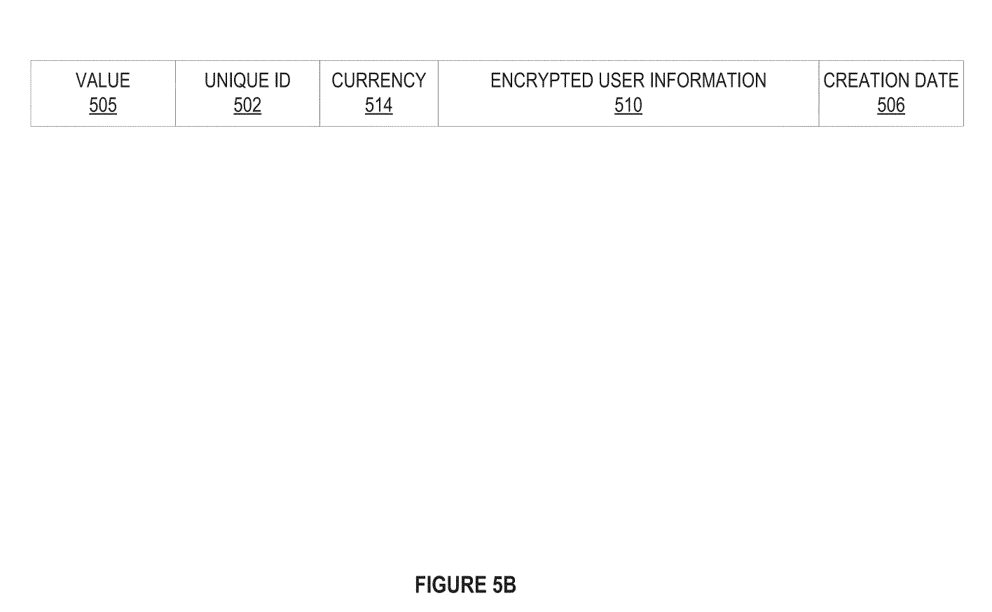

FIG. 5A depicts a block diagram of an exemplary data structure for the encrypted electronic currency log 134 for storing encrypted electronic currency records, in accordance with some example embodiments. In accordance with some example embodiments, the encrypted electronic currency log 134 includes a plurality of encrypted electronic currency records 502-1 to 502-N, each of which corresponds to a specific encrypted electronic currency unit issued to a client system (e.g., client system 102 in FIG. 1).

In some example embodiments, a respective encrypted electronic currency record 502 stores a unique identification (ID) 504. The unique ID 504 is an encrypted currency identification value not shared by other encrypted electronic currency records. Furthermore, the unique ID 504 matches a specific encrypted electronic currency unit with which the encrypted electronic currency record is associated. In some example embodiments, each encrypted electronic currency record 502 also includes a value field 505 (e.g., the amount that the associated encrypted electronic currency unit is worth), a creation date 506 (the timestamp at which the encrypted electronic currency unit was created), a status 508 representing whether the encrypted electronic currency unit is still valid (e.g., has not been used) or has been used already and is now invalid.

In some example embodiments, each encrypted electronic currency record 502 also includes encrypted data 510. In some example embodiments, the encrypted data 510 includes information identifying the client system (e.g., client system 102 or client app 104 in FIG. 1) associated with the owner of the encrypted electronic currency unit. In some example embodiments, the encrypted data 510 is encrypted such that only the client system (e.g., client system 102 in FIG. 1) associated with the encrypted electronic currency unit can decrypt it.

In some example embodiments, an encrypted electronic currency also includes a back-up location field 512 that identifies the storage location of the back-up for the encrypted electronic currency record in case one or more encrypted electronic currency units remain stored in a lost or stolen or inoperable client system. In some example embodiments, the encrypted electronic currency record includes the currency type 514, wherein the currency describes the units of value described by the value field 505. For example, the value field 505 could list 5 and the currency type list United States Dollars.

In some example embodiments, the encrypted electronic currency records 502 also include one or more other attributes 516.

FIG. 5B depicts a block diagram of an exemplary data structure for an encrypted electronic currency unit, in accordance with some example embodiments. In some example embodiments, an encrypted electronic currency unit includes a value field 505. The value field describes the worth or denomination of the encrypted electronic currency unit. For example, the value field 505 includes one of a fixed number of denomination values (1, 2, 4, 8, 16, and 32, or 1, 5, 10, 25, or other such denominations as may prove efficient). In other example embodiments, the value field can include any value necessary according to a request from a client system (e.g., client system 102 in FIG. 1).

In some example embodiments, the encrypted electronic currency unit includes a unique ID 504, wherein the unique ID is an encrypted electronic currency identification value for distinguishing each encrypted electronic currency unit from the others. No unique ID 504 can be reused.

In some example embodiments, an encrypted electronic currency includes the currency type 514, wherein the currency type 514 describes what units of value described by the value field 505. For example, the value field 505 could list 25 and the currency type lists United States cents. In some example embodiments, an encrypted electronic currency unit includes data 510 as described above. In some example embodiments, the encrypted electronic currency unit also includes a creation date 506 timestamp.

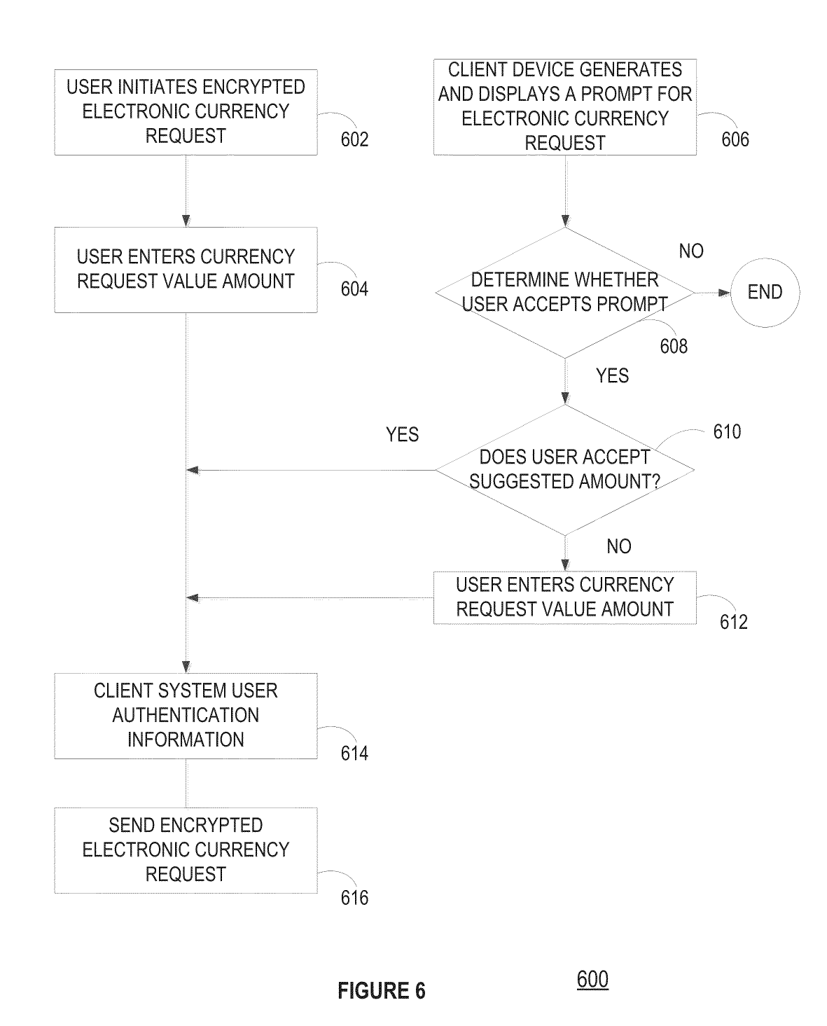

FIG. 6 is a flow diagram illustrating a method 600, in accordance with some example embodiments, for requesting encrypted electronic currency. Each of the operations shown in FIG. 6 may correspond to instructions stored in a computer memory or computer-readable storage medium. In some embodiments, the method described in FIG. 6 is performed by the computer device (e.g., client system 102 in FIG. 1). Accordingly, the method 600 is described merely by way of example with reference thereto. However, the method 600 can also be performed by any other suitable configuration of electronic hardware.

In some embodiments, the method 600 is performed at a computer device including one or more processors and memory storing one or more programs for execution by the one or more processors.

In some example embodiments, a user seeks to initiate (see operation 602) an encrypted electronic currency request. In some example embodiments, the user accesses a dedicated encrypted electronic currency application on the client system (e.g., client system 102 in FIG. 1). For example, the application has an “Add $ to Phone” button, and tapping the button initiates a request to withdraw funds from the user's demand deposit account at the user's financial institution. In some example embodiments, a user can make such a request manually. In some example embodiments, the client system (e.g., client system 102 in FIG. 1), as shown in operation 604, displays an input field to the user to enter a currency request value amount.

In other example embodiments, encrypted electronic currency requests can be generated automatically in a variety of ways based on any number triggering events that the user defines during setup or at other times. These triggers can be varied. In some example embodiments, example triggers include one of which could be when the encrypted electronic currency balance on the client system (e.g., client system 102 in FIG. 1) reaches a certain level, when the client system (e.g., client system 102 in FIG. 1) enters or leaves a certain location, the time of day, an external event such as a purchase made by the user or a message received by the device, or a repeating pattern set by the use. In other example embodiments, a trigger is activated when the client system (e.g., client system 102 in FIG. 1) has determined that additional denominations of encrypted electronic currency are desired so that system can pay any amount with an exact number of encrypted electronic currency units.

In accordance with a determination of a detected prearranged trigger, the client system (e.g., client system 102 in FIG. 1) generates and displays an additional currency prompt as shown at operation 606. For example, the client system (e.g., client system 102 in FIG. 1) determines that the total value of encrypted electronic currency units on the client system (e.g., client system 102 in FIG. 1) has dropped below $10. A pre-set trigger causes the client system (e.g., client system 102 in FIG. 1) to display a prompt stating “Add $20 of encrypted electronic currency?”

In some example embodiments, the client system (e.g., client system 102 in FIG. 1) determines (see operation 608) whether the user accepts the prompt. For example, if the user selects a button that says “Yes” in response to the above mentioned prompt. If the user selects “No”, the process ends.

In accordance with a determination that the user selects “Yes”, as shown at decision operation 610, the client system (e.g., client system 102 in FIG. 1) determines whether the user accepts the suggested value amount, for example, the prompt suggests $20 of additional currency. In accordance with a determination that the user wants a different amount of encrypted electronic currency value, the client system (e.g., client system 102 in FIG. 1) displays an input field that allows the user to enter a currency request value amount (see operation 612). In other example embodiments, the server system (e.g., server system 120 in FIG. 1) determines that the user accepts the suggested amount so no input field is needed.

In some example embodiments, the client system (e.g., client system 102 in FIG. 1) receives (see operation 614) user authentication information (e.g., a password, personal identification number (PIN), etc.) and sends the encrypted electronic currency request (see operation 616) to the server system (e.g., server system 120 in FIG. 1).

For example, the client system (e.g., client system 102 in FIG. 1) runs a dedicated encrypted electronic currency application that monitors the encrypted electronic currency balance on the client system (e.g., client system 102 in FIG. 1) and monitors for various trigger events set up by the user. Depending on the triggers and conditions set by the user, the program will alert the user when the user may want to add encrypted electronic currency to increase the balance on the client system. When the conditions or triggers set in the encrypted electronic currency application are met, the encrypted electronic currency application will automatically display a popup screen to ask the user if the user wants to add encrypted electronic currency to the encrypted electronic currency application on the client system (e.g., client system 102 in FIG. 1).

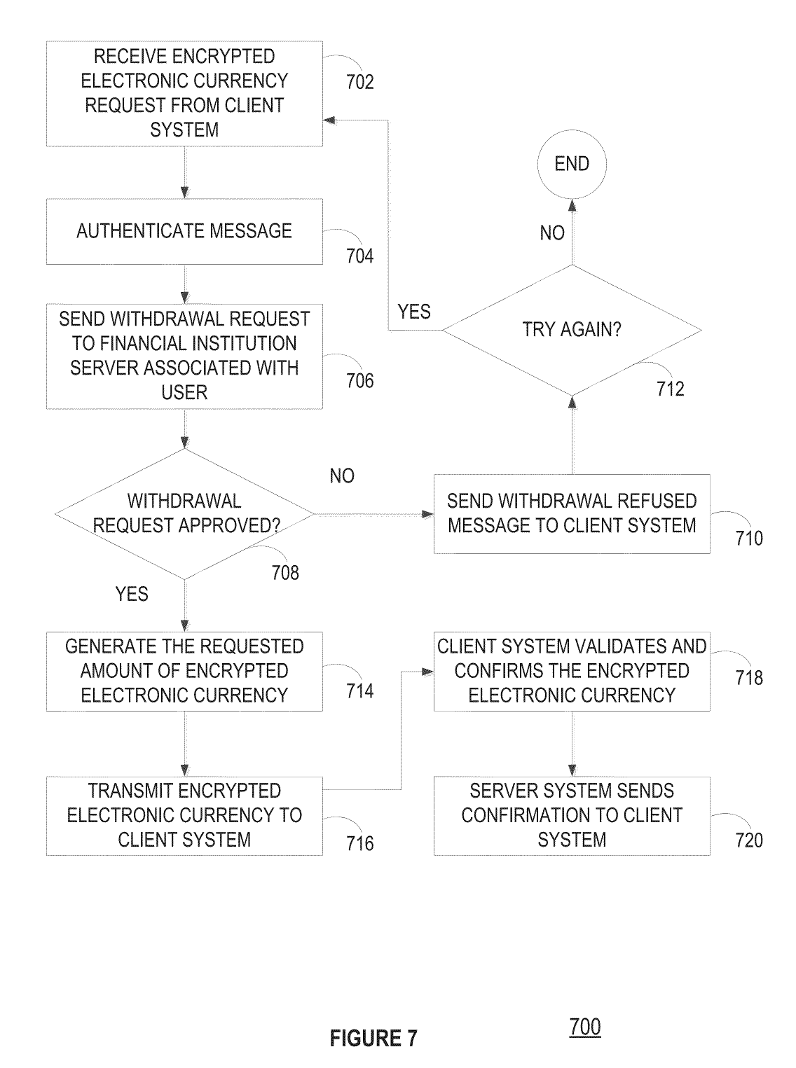

FIG. 7 is a flow diagram illustrating a method 700, in accordance with some example embodiments, for generating encrypted electronic currency. Each of the operations shown in FIG. 7 may correspond to instructions stored in a computer memory or computer-readable storage medium. Optional operations are indicated by dashed lines (e.g., boxes with dashed-line borders). In some embodiments, the method described in FIG. 7 is performed by the server system (e.g., server system 120 in FIG. 1). However, the method described can also be performed by any other suitable configuration of electronic hardware.

In some embodiments the method is performed at a server system (e.g., server system 120 in FIG. 1) including one or more processors and memory storing one or more programs for execution by the one or more processors.

In some example embodiments, the server system (e.g., server system 120 in FIG. 1) receives (see operation 702) an encrypted electronic currency request. For example, after the user enters a PIN, the encrypted electronic currency application sends an encrypted electronic currency request to the server system (e.g., server system 120 in FIG. 1). In some example embodiments, this encrypted electronic currency request includes some combination of cell phone number, cell phone subscriber identity module (SIM) identifier, the user personal identification (PIN), the user's demand deposit account (DDA) number, the user's automatic teller machine (ATM) card number, a unique device identifier that is part of the client system (120) hardware, a unique client app (104) identifier, and various other data generally used by electronic payment systems today.

In some example embodiments, the server system (e.g., server system 120 in FIG. 1) authenticates (see operation 704) the encrypted electronic currency request to insure that the request is not fraudulent. If the encrypted electronic currency request cannot be authenticated (e.g., the user identification information does not match the stored user identification information), the server system (e.g., server system 120 in FIG. 1) sends an error and retry message back to the client system (e.g., client system 102 in FIG. 1). If the encrypted electronic currency request is authenticated, the server system (e.g., server system 120 in FIG. 1) sends a withdrawal request (see operation 706) to a financial institution associated with the user (based on user account information). In some example embodiments, the server system (e.g., server system 120 in FIG. 1) sends a withdrawal request message to the financial institution system over the banking system's debit card or ATM network, properly formatted using existing banking standards to look just like an ATM withdrawal request from the user as if the user was using an ATM of the financial institution system or using an ATM of another financial institution.

In some example embodiments, the financial institution system receives the withdrawal request, and processes it in the same way it would if, for example, the user was standing at an ATM. In some embodiments, the financial institution system may or may not know if the user is using an ATM, or if the user requested a withdrawal from the client system (e.g., client system 102 in FIG. 1). The financial institution system processes the withdrawal request using the normal financial institution system procedure and either approves or declines the request (see operation 708). In some embodiments, the withdrawal may be limited to the current daily maximum established between the user and the financial institution system for ATM withdrawals.

In some example embodiments, if the withdrawal request is approved, the financial institution system sends an authorization to the server system (e.g., server system 120 in FIG. 1) to dispense funds for the withdrawal. This authorization is also the financial institution system's promise to reimburse the server system (e.g., server system 120 in FIG. 1) by transferring electronic funds from the user's account at the financial institution system to the server system (e.g., server system 120 in FIG. 1).

In some example embodiments, if the financial institution system does not approve the withdrawal request, the financial institution system sends a withdrawal refused message back to the server system (e.g., server system 120 in FIG. 1). The server system (e.g., server system 120 in FIG. 1) sends (see operation 710) a withdrawal refused message to the client system (e.g., client system 102 in FIG. 1). In some example embodiments, the client system (e.g., client system 102 in FIG. 1) determines, based on user input, that the user wants to try again (see operation 712) and the withdrawal process begins over again.

In some example embodiments, the financial institution system approves the withdrawal request, and the financial institution system sends an authorization to the server system (e.g., server system 120 in FIG. 1) to dispense funds for the withdrawal. In response to receiving the withdrawal authorization, the server system (e.g., server system 120 in FIG. 1) begins the process to generate encrypted electronic currency units equal in value to the authorized withdrawal amount.

In some example embodiments, the server system (e.g., server system 120 in FIG. 1) generates (see operation 714) the requested amount of encrypted electronic currency. For example, the server system (e.g., server system 120 in FIG. 1) encrypts one or more encrypted electronic currency units in the amount of the withdrawal, configured specifically for the client system (e.g., client system 102 in FIG. 1). In some example embodiments, the encrypted file of encrypted electronic currency is divided into units.

Each unit includes a number of components: serial number, denomination, financial institution system code, user device ID, client application ID, created date, and expiration date. Denominations could be in existing denominations of currency and coins, i.e. pennies, nickels, dimes, quarters, fifty cent pieces, dollar bills, $5 dollar bills, and so forth (10, 50, 250, 500, $1, $5, $20, $50), or could be in 1 cent, 2 cents, 8 cents, 16, 32, 64, 128, 512, and 1028 cent units, or any other denomination deemed to be efficient.

In some example embodiments, the server system (e.g., server system 120 in FIG. 1) determines the proper mix of denominations to generate such that the client system can buy goods and services at any price (up to the total value of the encrypted electronic currency units) with exact change. In some example embodiments, the server does this without looking at the existing balance or denominations on the client system. Additionally, the encrypted electronic currency application at the client system (e.g., client system 102 in FIG. 1) periodically analyzes its denominations from time to time and may request additional encrypted electronic currency units with a particular mix of denominations from the server system (e.g., server system 120 in FIG. 1) so that the client app can buy any amount up to the full amount of encrypted electronic currency stored on the client system with exact change. For example, if the client system runs out of 2 cent units, it sends a request to the server system (e.g., server system 120 in FIG. 1) to send some encrypted electronic currency units in that denomination.

In some example embodiments, since the user is not handling coins and paper currency, and will receive no physical change, and the client system (e.g., client system 102 in FIG. 1) is paying in the exact amount, the denomination of the units is irrelevant to the user. The server system (e.g., server system 120 in FIG. 1) will determine the optimal number and denomination of units of encrypted electronic currency to ensure that the amount transmitted to the encrypted electronic currency application running on the client system (e.g., client system 102 in FIG. 1) will have enough units of each denomination to pay for any amount of a purchase up to the total amount being transmitted.

In some example embodiments, the encrypted electronic currency file is encrypted with the server system (e.g., server system 120 in FIG. 1) private key to ensure authenticity, and the client system (e.g., client system 102 in FIG. 1) ID field is encrypted with the user's public key. The client system ID component of the encrypted electronic currency (encrypted electronic currency) prevents someone from copying files and spending the encrypted electronic currency units on another client system because only the client system (e.g., client system 102 in FIG. 1) whose User ID matches the ID embedded in the encrypted electronic currency can spend the encrypted electronic currency.

In some example embodiments, the serial number is encrypted with the server system public key (so that only the server system can decrypt the serial number), which ensures that each unit of encrypted electronic currency can only be validated by the server system 120. The server system (e.g., server system 120 in FIG. 1) digitally signs the encrypted electronic currency to prevent someone from spoofing the system with a counterfeit client application or by creating counterfeit encrypted electronic currency. The server system (e.g., server system 120 in FIG. 1) also configures the encrypted electronic currency units in a “spend once format.” The architecture of the system is such that when an encrypted electronic currency unit is spent by transferring it to a merchant system application, the merchant application transfers it to the server system (e.g., server system 120 in FIG. 1), which then retires the serial number of each unit.

In some example embodiments, the server system (e.g., server system 120 in FIG. 1) then transmits (see operation 716) the generated encrypted electronic currency units to the client system (e.g., client system 102 in FIG. 1). In some example embodiments, the message containing the encrypted electronic currency is itself encrypted.

In some example embodiments, when the encrypted electronic currency application on the client system (e.g., client system 102 in FIG. 1) receives the encrypted electronic currency, the encrypted electronic currency application on the client system (e.g., client system 102 in FIG. 1) immediately decrypts the encrypted electronic currency using a combination of the user's private key and the encrypted electronic currency's public key to validate (see operation 718) and confirm that the amount received is the amount requested, and that the User ID embedded in the encrypted electronic currency matches the User ID or other authentication criteria in the client system (e.g., client system 102 in FIG. 1). The encrypted electronic currency application 104 on the client system (e.g., client system 102 in FIG. 1) sends (see operation 718) the server system (e.g., server system 120 in FIG. 1) a confirmation of receipt. The server system (e.g., server system 120 in FIG. 1) then sends (see operation 720) a confirmation to the encrypted electronic currency application on the client system (e.g., client system 102 in FIG. 1). The encrypted electronic currency application on the client system (e.g., client system 102 in FIG. 1) uses such confirmation from server system (e.g., server system 120 in FIG. 1) to display an increase in the encrypted electronic currency balance on the client system (e.g., client system 102 in FIG. 1) in the amount of the withdrawal (for example, $100.)

In some example embodiments, the server system (e.g., server system 120 in FIG. 1) maintains a record of only the dollar amount of the transfer of the encrypted electronic currency to the client system (e.g., client system 102 in FIG. 1). Prior to sending the encrypted electronic currency, the server system (e.g., server system 120 in FIG. 1) generates random serial numbers for the outbound encrypted electronic currency units. These serial numbers are automatically encrypted using the public key of a user. While the server system (e.g., server system 120 in FIG. 1) keeps a record of all serial numbers ever sent to all client system user applications and keeps a log of which serial numbers have been spent, the server system (e.g., server system 120 in FIG. 1) keeps no record of which serial numbers of encrypted electronic currency units it sent to which client system (e.g., client system 102 in FIG. 1). Thus, the server system (e.g., server system 120 in FIG. 1) does not know which user has which serial numbers.

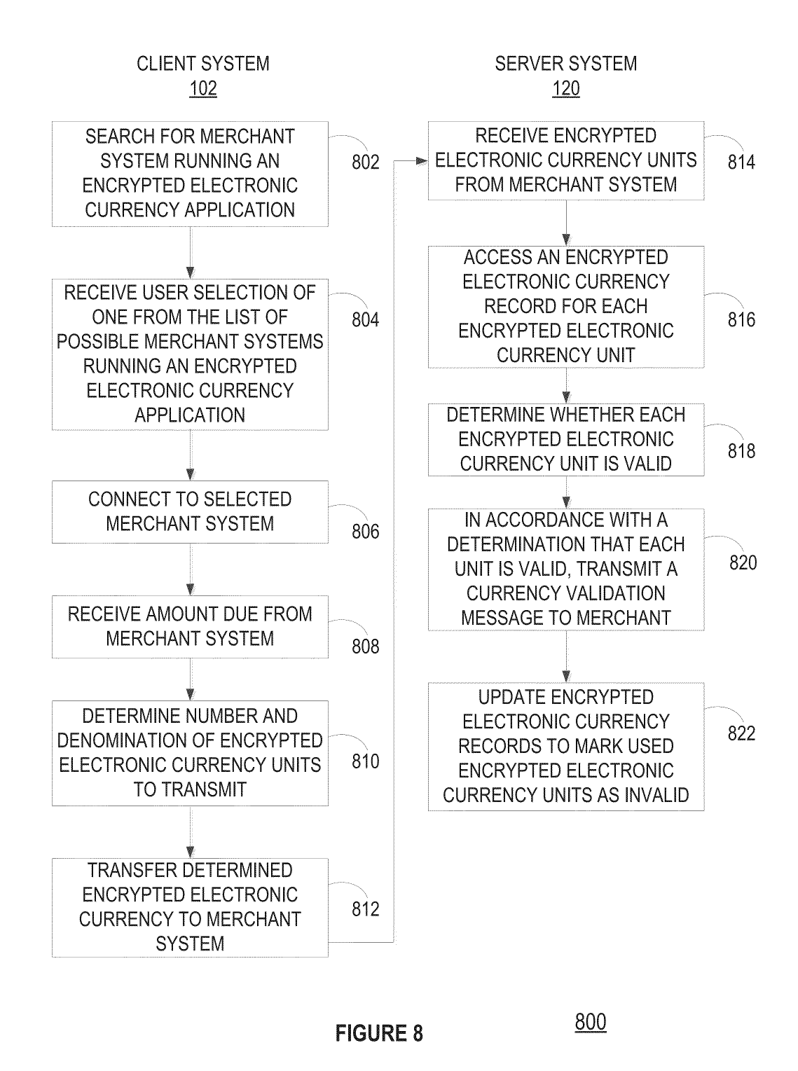

FIG. 8 is a flow diagram illustrating a method 800, in accordance with some example embodiments, for processing and validating encrypted electronic currency for transactions. Each of the operations shown in FIG. 8 may correspond to instructions stored in a computer memory or computer-readable storage medium. In some embodiments, the method described in FIG. 8 is performed by the server system (e.g., server system 120 in FIG. 1). However, the method described can also be performed by any other suitable configuration of electronic hardware.

In some embodiments, the method is performed at a server system (e.g., server system 120 in FIG. 1) including one or more processors and memory storing one or more programs for execution by the one or more processors.

In some example embodiments, a user with a client system (e.g., client system 102 in FIG. 1) enters a store, selects a good or service, and approaches a checkout area (e.g., a counter with register or other point of sales system, or a mobile checkout person with a mobile device, or a self-checkout system, or some other checkout option), opens the encrypted electronic currency application on the client system (e.g., client system 102 in FIG. 1).

In some example embodiments, a client system (e.g., client system 102 in FIG. 1) running an encrypted electronic currency application searches (see operation 802) for nearby merchant systems running a corresponding encrypted electronic currency application, using any one of a number of possible wireless protocols, (e.g., Bluetooth, Bluetooth low energy, Wi-Fi, Near Field Communications (NFC), or any of a number of current wireless standards, or ultrasonic, or video, or a wireless protocol yet to be invented) and finds one or a list of available merchant systems currently running an encrypted electronic currency application.

In some example embodiments, if the encrypted electronic currency application on the client system (e.g., client system 102 in FIG. 1) finds just one merchant system running an encrypted electronic currency application, then the client system (e.g., client system 102 in FIG. 1) connects to that single merchant system, using any of a variety of secure connection protocols. In other example embodiments, if the encrypted electronic currency application on the client system (e.g., client system 102 in FIG. 1) finds a list of available merchant systems running an encrypted electronic currency system, then the client system (e.g., client system 102 in FIG. 1) receives user input selecting (see operation 804) one of the possible merchant systems (e.g., the user recognizes the name of the store in the list, or the sales clerk tells the user which merchant system to select).

In some example embodiments, the client system (e.g., client system 102 in FIG. 1) connects (see operation 806) to the selected merchant system. In some example embodiments, if the client system (e.g., client system 102 in FIG. 1) is not able to connect to the merchant system, then a user (e.g., store clerk) of the merchant system taps the merchant system screen to cancel the connection attempt, and the encrypted electronic currency application on the merchant system generates a unique code for the client system (e.g., client system 102 in FIG. 1). This code is relayed to the client system (e.g., client system 102 in FIG. 1) and used to connect to the merchant system (e.g., the clerk verbally gives this code to the user, who enters the code into the client system and taps “connect”).

In some example embodiments, the client system (e.g., client system 102 in FIG. 1) receives (see operation 808) the amount due (e.g., transaction total) from the merchant system. For example, the clerk enters the transaction total (for example, $11.66) into the merchant system, then taps “send to buyer” (the total is the equivalent of a one-time random secret code), and the merchant system communicates the total purchase amount to the client system (e.g., client system 102 in FIG. 1).

In some example embodiments, the client system (e.g., client system 102 in FIG. 1) determines (see operation 810) the number and denomination of encrypted electronic currency units to transmit to the merchant system. For example, the encrypted electronic currency application on the client system (e.g., client system 102 in FIG. 1) invokes an intelligent algorithm to determine the appropriate denominations of encrypted electronic currency to pay the exact amount of the transaction. The particular units determined will depend on the denominations available and the total amount of the sale. Since each unit may require the same effort to process, using the fewest units of encrypted electronic currency will be most efficient for network transmission and computational effort.

In some example embodiments, the client system (e.g., client system 102 in FIG. 1) transfers (see operation 812) the determined encrypted electronic currency units to the merchant system. In some example embodiments, the user enters a PIN to authenticate the transaction. If required by the encrypted electronic currency application, the user must enter the correct PIN before the purchase transaction can proceed. In some embodiments, the user will have the option to require a PIN, or not require a PIN for any transaction, and/or for transactions below a certain amount. For example, each user can determine the level of security required to spend encrypted electronic currency units from their associated client system (e.g., client system 102 in FIG. 1). A user can determine not to enable PIN authentication requirement to enable a simplified and fast process for spending encrypted electronic currency units. Other users can require PIN authentication to prevent another from spending the encrypted electronic currency units if the client system (e.g., client system 102 in FIG. 1) is lost or stolen.

In some example embodiments, the transmitted encrypted electronic currency units are transmitted without any user identifying information that can be accessed by the merchant system or server system (e.g., server system 120 in FIG. 1). In other example embodiments, the user can choose to send a user or account identifier with the encrypted electronic currency units to allow the transaction to be tracked (e.g., the user wants the merchant to keep track of the transaction to earn loyalty points or other frequent purchaser rewards). In some example embodiments, the encrypted electronic currency units and any other information transferred to the merchant system are encrypted prior to transmission. The merchant system then transfers the received encrypted electronic currency to the server system (e.g., server system 120 in FIG. 1).

In some example embodiments, the server system (e.g., server system 120 in FIG. 1) receives (see operation 814) encrypted electronic currency from a merchant system. If necessary the server system (e.g., server system 120 in FIG. 1) decrypts the message (e.g., using the merchant system's public key (to verify the merchant is who he says he is) and the server system's private key (to extract the serial number and verify the source as originally created by the server system)).

In some example embodiments, the server system (e.g., server system 120 in FIG. 1) accesses (see operation 816) encrypted electronic currency records for each received encrypted electronic currency unit.

In some example embodiments, the server system (e.g., server system 120 in FIG. 1) determines (see operation 818) whether all of the encrypted electronic currency units are still valid based on their corresponding encrypted electronic currency records. For example, the server system checks the serial numbers for each unit against the encrypted electronic currency record log (e.g., a serial number ledger) (e.g., records for each unit). If serial numbers are unused, then the server system sends (see operation 820) a “currency validation” message to the merchant system, authorizing it to accept the encrypted electronic currency units as payment.

If one or more of the encrypted electronic currency units are invalid (e.g., they have been used previously), the server system (e.g., server system 120 in FIG. 1) sends a message to the merchant system to refuse acceptance of the one or more invalid units. In some example embodiments, the server system (e.g., server system 120 in FIG. 1) also transmits the value of the invalid encrypted electronic currency units (e.g., so the merchant system can request the additional funds from the client system (e.g., client system 102 in FIG. 1)). In some example embodiments, a “refuse payment” message ends the potential transaction with the client system (e.g., client system 102 in FIG. 1) and the user must pay with physical cash, or a check, debit card, or credit card.

In some example embodiments, the encrypted electronic currency application running on the merchant system (140 in FIG. 1) displays “Paid” or other such message on the display of the merchant system (e.g., merchant system 140 in FIG. 1), and sends a message to the client system to display “Paid” or other such message on the display of the client system. The encrypted electronic currency application running on the client system (102 in FIG. 1) deletes the encrypted electronic currency units from the client system 102. The merchant system sends a message to the server system (e.g., server system 120 in FIG. 1) that it has been paid and to retire (e.g., marked as invalid) the serial numbers previously sent. In some example embodiments, the server system (e.g., server system 120 in FIG. 1) then updates (see operation 822) the encrypted electronic currency records of the received encrypted electronic currency units to mark them as invalid or used.

For example, the server system (e.g., server system 120 in FIG. 1) retires the serial numbers (marks them as spent or invalid) and the server system 120 accumulates the value of the retired encrypted electronic currency units into the merchant system's account. At this point, the purchase transaction is complete.

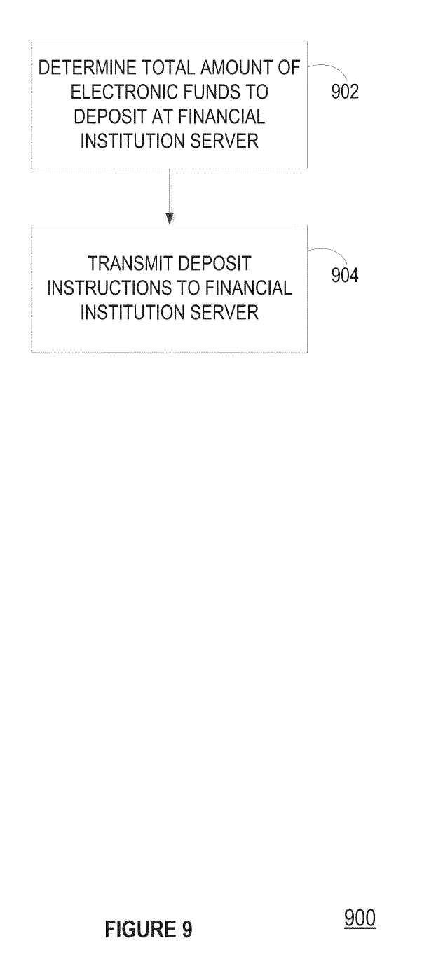

FIG. 9 is a flow diagram illustrating a method for depositing electronic funds as necessary, in accordance with some example embodiments. Each of the operations shown in FIG. 9 may correspond to instructions stored in a computer memory or computer-readable storage medium. In some embodiments, the method described in FIG. 9 is performed by the server system (e.g., server system 120 in FIG. 1). However, the method described can also be performed by any other suitable configuration of electronic hardware.

In some embodiments the method is performed at a server system (e.g., server system 120 in FIG. 1) including one or more processors and memory storing one or more programs for execution by the one or more processors.

In some example embodiments, the server system (e.g., server system 120 in FIG. 1) has authorized a number of transactions during a given period of time (e.g., a business day). In some example embodiments, the server system (e.g., server system 120 in FIG. 1) determines (see operation 902) the sum of all payments to each merchant system and determines the balance of each merchant's encrypted electronic currency.

For example, the server system (e.g., server system 120 in FIG. 1) creates an electronic file of balances, Merchant names, Merchant Bank names, account numbers, and Merchant Bank routing numbers, and formats this file in a format acceptable to the server system (e.g., server system 120 in FIG. 1). The server system communicates this file to the financial system (e.g., system 123 in FIG. 1) associated with the server system (e.g., server system 120 in FIG. 1) with instructions to send a deposit to one or more financial institution systems. The financial system (e.g., system 123 in FIG. 1) associated with the server system (e.g., server system 120 in FIG. 1) sends (see operation 904) the financial deposit instructions per the instructions from the server system (e.g., server system 120 in FIG. 1). For example, the financial system (e.g., system 123 in FIG. 1) associated with the server system (e.g., server system 120 in FIG. 1 sends automated cleaning house (ACH) deposits to each bank following the normal national automated clearing house association (NACHA) protocol used by the banking community. On the settlement date for each deposit, the financial system (e.g., system 123 in FIG. 1) associated with the server system (e.g., server system 120 in FIG. 1) debits the server system (e.g., server system 120 in FIG. 1) account for the appropriate amount of electronic funds for each transfer.

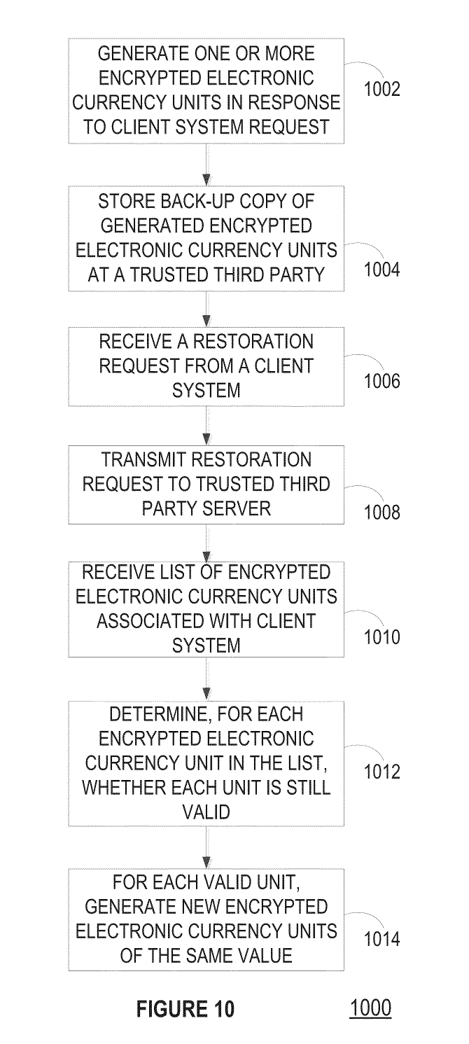

FIG. 10 is a flow diagram illustrating a method 1000, in accordance with some example embodiments, for cancelling and replacing encrypted electronic currency units stored in a lost or stolen or inoperable client system. Each of the operations shown in FIG. 10 may correspond to instructions stored in a computer memory or computer-readable storage medium. Optional operations are indicated by dashed lines (e.g., boxes with dashed-line borders). In some embodiments, the method described in FIG. 10 is performed by the server system (e.g., server system 120 in FIG. 1) and encryption system 121 and backup storage system 150. However, the method described can also be performed by any other suitable configuration of electronic hardware.

In some embodiments the method is performed at a server system (e.g., server system 120 in FIG. 1) including one or more processors and memory storing one or more programs for execution by the one or more processors.

In some example embodiments, the server system (e.g., server system 120 in FIG. 1) generates (see operation 1002) one or more encrypted electronic currency units in response to a request from a client system (e.g., client system 102 in FIG. 1). For example, a user requests a withdrawal of dollar funds from the financial institution system 170 and the server system (e.g., server system 120 in FIG. 1) deposits encrypted electronic currency into the encrypted electronic currency application running on the client system (e.g., client system 102 in FIG. 1).

In some example embodiments, the server system (e.g., server system 120 in FIG. 1) stores (see operation 1004) a back-up copy of the generated encrypted electronic currency to a trusted third party. In some example embodiments, backups are only generated for users who opt into the recovery feature when they register for the system. In some example embodiments, the trusted third party stores the encrypted electronic currency, but cannot spend it and cannot decrypt it because the trusted third party does not have the user's private key. In some example embodiments, the encrypted electronic currency sent to the trusted third party requires two keys to decrypt: the user's private key and the server system private key.

In some example embodiments, the server system (e.g., server system 120 in FIG. 1) receives (see operation 1006) a restoration request from a client system (e.g., client system 102 in FIG. 1), wherein the client system (e.g., client system 102 in FIG. 1) also sends a private key to the trusted third party. In some example embodiments, the restoration request indicates that a client system (e.g., client system 102 in FIG. 1) is lost or stolen or inoperable.

In some example embodiments, the server system (e.g., server system 120 in FIG. 1) transmits (see operation 1008) the restoration request as well as a key associated with the server system to the trusted third party.

In some example embodiments, the trusted third party uses both keys to decrypt all of the encrypted electronic currency that is associated with the requesting client system (e.g., client system 102 in FIG. 1). The server system (e.g., server system 120 in FIG. 1) receives (see operation 1010) the list of encrypted electronic currency units associated with the requesting client system (e.g., client system 102 in FIG. 1) (or a user account associated with a lost or destroyed client system).

The server system (e.g., server system 120 in FIG. 1) then determines (see operation 1012), for each respective encrypted electronic currency unit on the list of encrypted electronic currency units associated with the client system (e.g., client system 102 in FIG. 1), whether the respective encrypted electronic currency unit is still valid. For each valid encrypted electronic currency unit, the server system (e.g., server system 120 in FIG. 1) creates (see operation 1014) and sends new encrypted electronic currency units of the same value to the user's new client system (e.g., client system 102 in FIG. 1). These replacement encrypted electronic currency units are encrypted with the Device ID of the new client system (e.g., client system 102 in FIG. 1) and cannot be spent using the old client system (e.g., client system 102 in FIG. 1).

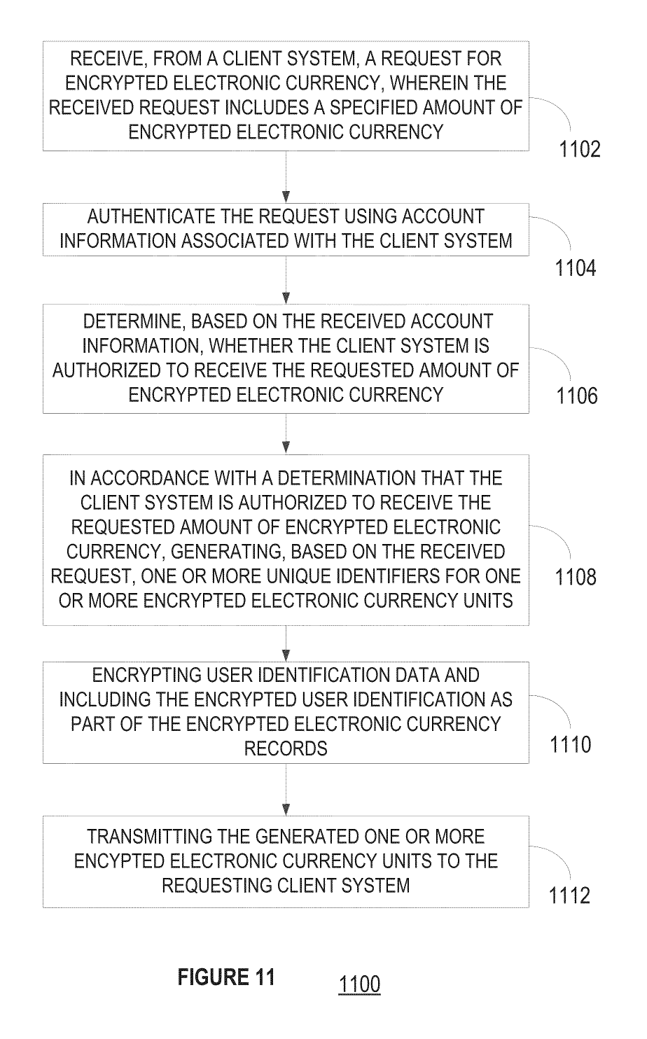

FIG. 11 is a flow diagram illustrating a method 1100, in accordance with an example embodiment, for generating encrypted electronic currency based on a request from a client system. Each of the operations shown in FIG. 11 may correspond to instructions stored in a computer memory 406 or computer readable storage medium.

In some example embodiments, the method 1100 is performed at a server system (e.g., the server system 120 in FIG. 1) including one or more processors and memory 406 storing one or more programs for execution by the one or more processors.

In some example embodiments, the server system (e.g., the server system 120 in FIG. 1) receives (see operation 1102), from a client system (e.g., client system 102 in FIG. 1), a request for one or more encrypted electronic currency units, wherein the received request includes a specified amount of encrypted electronic currency. For example, a client system (e.g., client system 102 in FIG. 1) sends a request for fifty dollars to the server system (e.g., server system 120 in FIG. 1).

In some example embodiments, the server system (e.g., server system 120 in FIG. 1) authenticates (see operation 1104) the request using stored account information associated with the client system (e.g., client system 102 in FIG. 1). For example, a request is received from client system B to transfer encrypted electronic currency to client system B. The server system (e.g., server system 120 in FIG. 1) authenticates the request by checking a password or other received authentication information and determining whether the user is authorized to transfer funds to client system B.

In some example embodiments, the server system (e.g., server system 120 in FIG. 1) determines (see operation 1106) whether the client system (e.g., client system 102 in FIG. 1) is authorized to receive the requested number or amount of encrypted electronic currency. This is accomplished using stored financial account information or account information received from the client system (e.g., client system 102 in FIG. 1) as part of the request. For example, client system A sends a request for one hundred dollars of encrypted electronic currency units. The server system (e.g., server system 120 in FIG. 1) determines financial account information for client system A stored at the server system (e.g., server system 120 in FIG. 1). The server system (e.g., server system 120 in FIG. 1) then sends a withdrawal request to the financial institution stored in the account information. If the financial institution system approves the withdrawal, the request is considered authenticated and approved.

In some example embodiments, and in accordance with a determination that the client system is authorized to receive the requested amount of encrypted electronic currency, the server system (e.g., server system 120 in FIG. 1) generates (see operation 1108), based on the received request, one or more unique identifiers for one or more encrypted electronic currency units. In some example embodiments, the server system (e.g., server system 120 in FIG. 1) determines the number of encrypted electronic currency units needed based on the requested value and the encrypted electronic currency units currently stored at the client system (e.g., client system 102 in FIG. 1).

In some example embodiments, the server system (e.g., server system 120 in FIG. 1) encrypts (see operation 1110) user identification data and includes that encrypted user identification data as part of the encrypted electronic currency unit. In this way, the client system (e.g., client system 102 in FIG. 1) can validate that any encrypted electronic currency units transmitted to them are authentic, but other parties cannot determine, from the encrypted electronic currency unit itself, the client system (e.g., client system 102 in FIG. 1) with which it is associated. In some example embodiments, user identification data includes a user account number, an international mobile station equipment identity (IMEI) number associated with the client system (e.g., client system 102 in FIG. 1), a unique device identifier (UDID) number, date, and so on.

In some example embodiments, once the encrypted electronic currency unit has been generated, a corresponding encrypted electronic currency record is generated and stored in a database at the server system (e.g., server system 120 in FIG. 1). Each encrypted electronic currency record includes all of the data associated with its corresponding encrypted electronic currency unit, as well as a validity entry. Each encrypted electronic currency is marked valid upon generation. However, when the encrypted electronic currency unit is used (e.g., to purchase a good or service) then the corresponding encrypted electronic currency record is updated to mark the encrypted electronic currency unit as invalid (or no longer valid). In some example embodiments, each encrypted electronic currency unit can only be used once

In some example embodiments, the server system (e.g., server system 120 in FIG. 1) transmits (see operation 1112) the generated one or more encrypted electronic currency units to the requesting client system (e.g., client system 102 in FIG. 1).

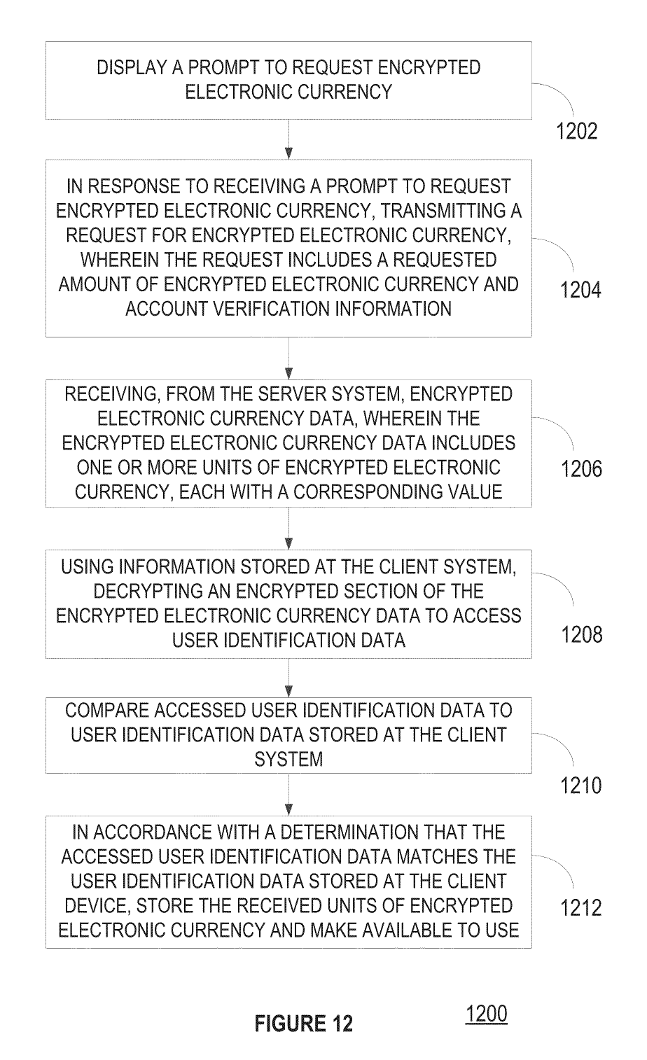

FIG. 12 is a flow diagram illustrating a method 1200 for requesting and validating encrypted electronic currency units from a server system (e.g., server system 120 in FIG. 1), in accordance with some example embodiments. Each of the operations shown in FIG. 12 may correspond to instructions stored in a computer memory or computer-readable storage medium. In some embodiments, the method described in FIG. 12 is performed by the client system (e.g., client system 102 in FIG. 1). However, the method described can also be performed by any other suitable configuration of electronic hardware.

In some embodiments the method is performed at a client system (e.g., client system 102 in FIG. 1) including one or more processors and memory storing one or more programs for execution by the one or more processors.

In some example embodiments, the client system (e.g., a client app, 104 on a client system 102 in FIG. 1) generates (see operation 1202) a prompt to request additional encrypted electronic currency units. For example, the client system (e.g., a client app, 104 on a client system 102 in FIG. 1) generates a prompt whenever the total balance of encrypted electronic currency falls below a predetermined level, or for example, the client application may generate a prompt to request encrypted electronic currency units based on a monthly reminder to pay the utility bill.

In some example embodiments, in response to generating a prompt to request additional encrypted electronic currency, the client system (e.g., client system 102 in FIG. 1) receives an input from the user to confirm the request for additional encrypted electronic currency and the client system transmits (see operation 1204) a request for additional encrypted electronic currency units, wherein the request includes a requested amount of encrypted electronic currency and account verification information.

In some example embodiments, the client system (e.g., client system 102 in FIG. 1) receives (see operation 1206) one or more encrypted electronic currency units from the server system (e.g., server system 120 in FIG. 1), with each encrypted electronic currency having an associated value. For example, the client system (e.g., client system 102 in FIG. 1) receives ten encrypted electronic currency units from the server system (e.g., server system 120 in FIG. 1): two in one cent denominations, two in two cent denominations, three in four cent denominations, one in an eight cent denomination, and two in sixteen cent denominations.

In some example embodiments, the client system (e.g., client system 102 in FIG. 1) uses (see operation 1208) information stored at the client system (e.g., client system 102 in FIG. 1) to decrypt the encrypted section of the encrypted electronic currency units to access user and/or client system identification data. For example, the client system (e.g., client system 102 in FIG. 1) uses a private key stored at the client system (e.g., client system 102 in FIG. 1) to decrypt the encrypted section of the encrypted electronic currency units. Once the client system identification data is decrypted, the client system (e.g., client system 102 in FIG. 1) compares (see operation 1210) the decrypted client system identification data against client system identification data stored at the client system (e.g., client system 102 in FIG. 1).

In accordance with a determination that the decrypted user identification data in the encrypted electronic currency units match the user identification data stored at the client system, the client system (e.g., client system 102 in FIG. 1) stores (see operation 1212) the encrypted electronic currency units and makes them available to buy goods or services. However, if the client system identification data does not match, the client system (e.g., client system 102 in FIG. 1) cannot use the encrypted electronic currency units and the encrypted electronic currency application on the client system (e.g., client system 102 in FIG. 1) will notify the server system (e.g., server system 120 in FIG. 1) of the mistake.

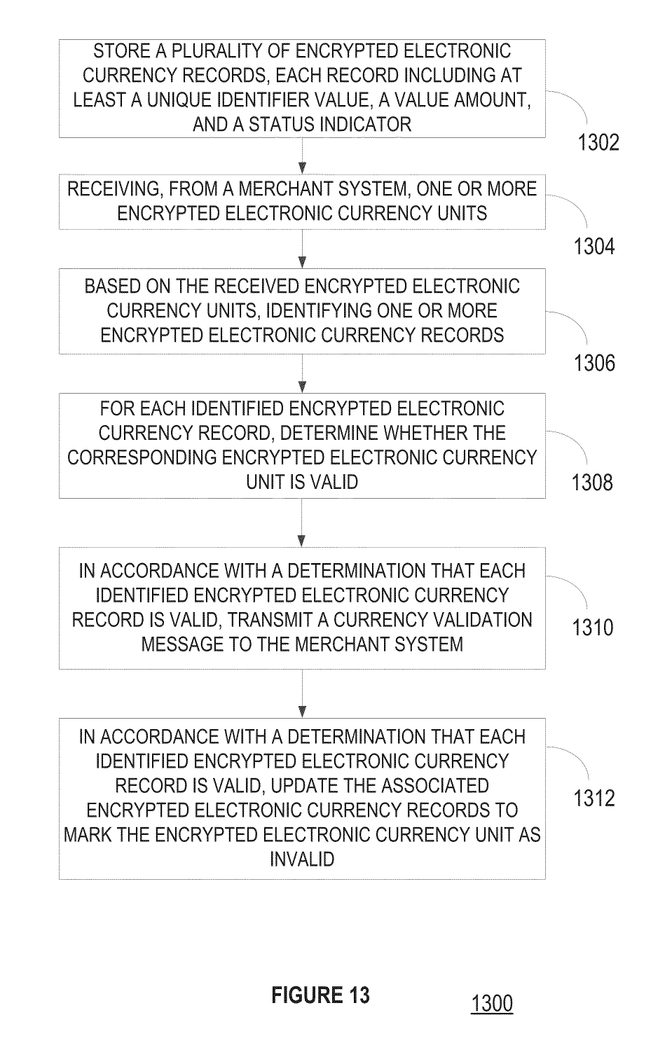

FIG. 13 is a flow diagram illustrating a method 1300 for validating encrypted electronic currency in accordance with some example embodiments. Each of the operations shown in FIG. 13 may correspond to instructions stored in a computer memory or computer-readable storage medium. Optional operations are indicated by dashed lines (e.g., boxes with dashed-line borders). In some embodiments, the method described in FIG. 13 is performed by the server system (e.g., server system 120 in FIG. 1) and encryption system 121 and backup storage system 150. However, the method described can also be performed by any other suitable configuration of electronic hardware.

In some embodiments the method is performed at a server system (e.g., server system 120 in FIG. 1) including one or more processors and memory storing one or more programs for execution by the one or more processors.

In some example embodiments, the server system (e.g., server system 120 in FIG. 1) stores (see operation 1302) a plurality of encrypted electronic currency records in an encrypted electronic currency log 134, wherein each record includes at least a unique identifier value, a value amount, and a status indicator. In some example embodiments, the status indicator is marked as either valid (e.g., it has not been used) or invalid (e.g., the encrypted electronic currency unit has been used).

The server system (e.g., server system 120 in FIG. 1) receives (see operation 1304) one or more encrypted electronic currency units from a merchant system (e.g., system 140 in FIG. 1). In some example embodiments, the merchant system runs an application received from a server system operated by the merchant or in a cloud configuration run by the merchant or the merchant's cloud system supplier, (in any case, e.g., an encrypted electronic currency application) and receives encrypted electronic currency units from customers. The merchant system (e.g., system 140 in FIG. 1) then sends the encrypted electronic currency units to the server system (e.g., server system 120 in FIG. 1) to be validated. The merchant transmission has been encrypted with the merchant's private key, and the server system must decrypt the encrypted electronic currency units with the merchant's public key, insuring that the server system knows which merchant is sending the encrypted electronic currency units.

In some example embodiments, the server system (e.g., server system 120 in FIG. 1) identifies (see operation 1306) one or more encrypted electronic currency records based on the received encrypted electronic currency units. For example, each encrypted electronic currency unit has a unique identifier value that can be used to identify an encrypted electronic currency record with a matching unique identifier value.

In some example embodiments, the server system (e.g., server system 120 in FIG. 1) determines (see operation 1308), for each identified encrypted electronic currency record, whether the corresponding encrypted electronic currency unit is valid. For example, the server system (e.g., server system 120 in FIG. 1) receives an encrypted electronic currency unit with serial number 02345. The server system (e.g., server system 120 in FIG. 1) then accesses the encrypted electronic currency record with the same serial number. The server system (e.g., server system 120 in FIG. 1) determines whether the encrypted electronic currency unit is valid based on the validity data field of the encrypted electronic currency record.

In some example embodiments, in accordance with a determination that each identified encrypted electronic currency record is valid, the server system (e.g., server system 120 in FIG. 1) transmits (see operation 1310) a currency validation message to the merchant system (e.g., merchant system 140 of FIG. 1). In accordance with a determination that any of the identified encrypted electronic currency records are not valid, the server system (e.g., server system 120 of FIG. 1) transmits an error message to the merchant system, wherein the error message indicates the value of the invalid encrypted electronic currency units. For example, if one encrypted electronic currency unit with a value of 50 cents is determined to be invalid, the server system (e.g., server system 120 in FIG. 1) transmits an error message to the merchant system noting that the 50 cent encrypted electronic currency unit was not valid.

In some example embodiments, the merchant server system requests additional encrypted electronic currency units from the client system (e.g., client system 102 in FIG. 1) to complete the transaction. If additional encrypted electronic currency units are supplied, the additional encrypted electronic currency units are validated by the server system (e.g., server system 120 in FIG. 1). Once the encrypted electronic currency units have been validated by the server system (e.g., server system 120 in FIG. 1), the server system (e.g., server system 120 in FIG. 1) updates (see operation 1312) the associated encrypted electronic currency record to mark the encrypted electronic currency unit as invalid.

In some example embodiments, if no additional encrypted electronic currency units are added, the valid encrypted electronic currency units are not marked as invalid by the server system (e.g., server system 120 in FIG. 1) and remain on the client system (e.g., client system 102 in FIG. 1)

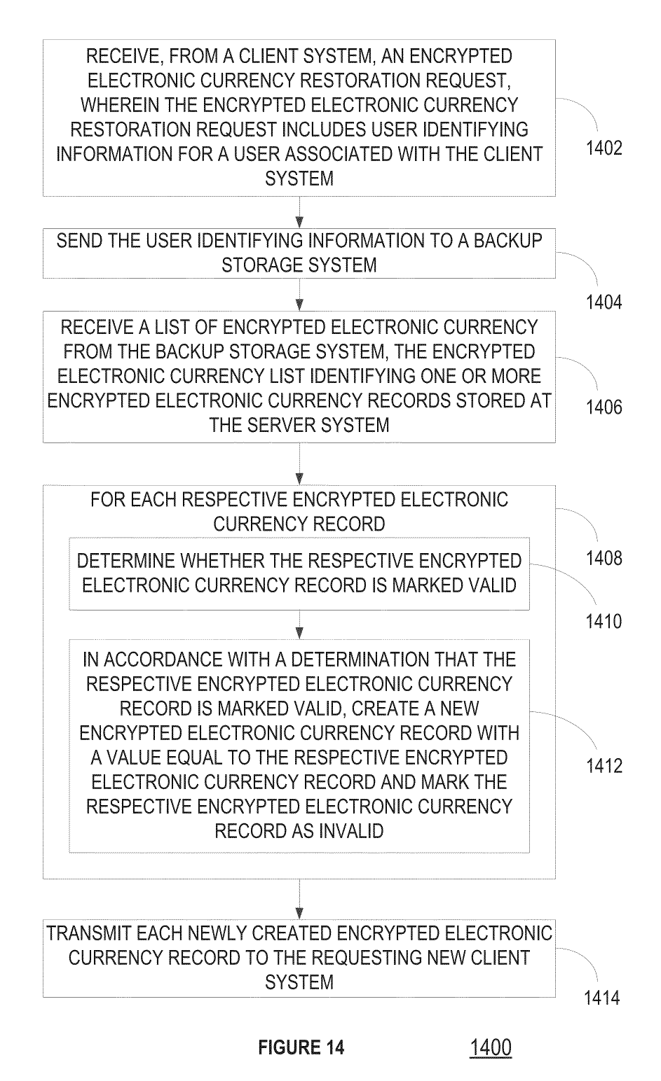

FIG. 14 is a flow diagram illustrating a method for cancelling and replacing encrypted electronic currency stored in a lost or stolen or inoperable client system in accordance with some example embodiments. Each of the operations shown in FIG. 14 may correspond to instructions stored in a computer memory or computer-readable storage medium. Optional operations are indicated by dashed lines (e.g., boxes with dashed-line borders). In some embodiments, the method described in FIG. 14 is performed by the server system (e.g., server system 120 in FIG. 1). However, the method described can also be performed by any other suitable configuration of electronic hardware.

In some embodiments the method is performed at a server system (e.g., server system 120 in FIG. 1) (or by an encryption system (e.g., system 121 of FIG. 1) or backup storage system (e.g., system 150 of FIG. 1)) including one or more processors and memory storing one or more programs for execution by the one or more processors.

In some example embodiments, the server system (e.g., server system 120 in FIG. 1) receives (see operation 1402) an encrypted electronic currency restoration request, wherein the encrypted electronic currency restoration request includes user identifying information for a user associated with the client system (e.g., client system 102 in FIG. 1). For example, if a client system (e.g., client system 102 in FIG. 1) device is lost or stolen or inoperable and the user wants to recover the encrypted electronic currency units stored thereon, the client system (e.g., client system 102 in FIG. 1) sends a currency restoration request to the server system (e.g., server system 120 in FIG. 1).

In some example embodiments, the server system (e.g., server system 120 in FIG. 1) accesses user identifying information (e.g., user ID) from a database associated with the server system (e.g., server system 120 in FIG. 1). In some example embodiments, the backup storage system is a trusted third party system. The server system (e.g., server system 120 in FIG. 1) transmits (see operation 1404) the user identifying information to the backup storage system.

In some example embodiments, the server system (e.g., server system 120 in FIG. 1) receives (see operation 1406) a list of one or more encrypted electronic currency units associated with the user identifying information from the backup storage system.

In some example embodiments, at operation 1408, for each encrypted electronic currency unit in the list of encrypted electronic currency units (see operation 1408), the server system (e.g., server system 120 in FIG. 1) determines (see operation 1410) whether the respective encrypted electronic currency record is marked valid. In accordance with a determination that the respective encrypted electronic currency record is marked valid, the server system (e.g., server system 120 in FIG. 1) creates (see operation 1412) a new encrypted electronic currency record with a value equal to the respective encrypted electronic currency record and marks the respective encrypted electronic currency record as invalid. In this way, if the client system is recovered or if a person who stole the client system tries to use the encrypted electronic currency units, the encrypted electronic currency units cannot be spent because they are marked as invalid.

In some example embodiments, the server system (e.g., server system 120 in FIG. 1) transmits (see operation 1414) each newly created encrypted electronic currency unit to the requesting client system (e.g., client system 102 in FIG. 1).

### Software Architecture

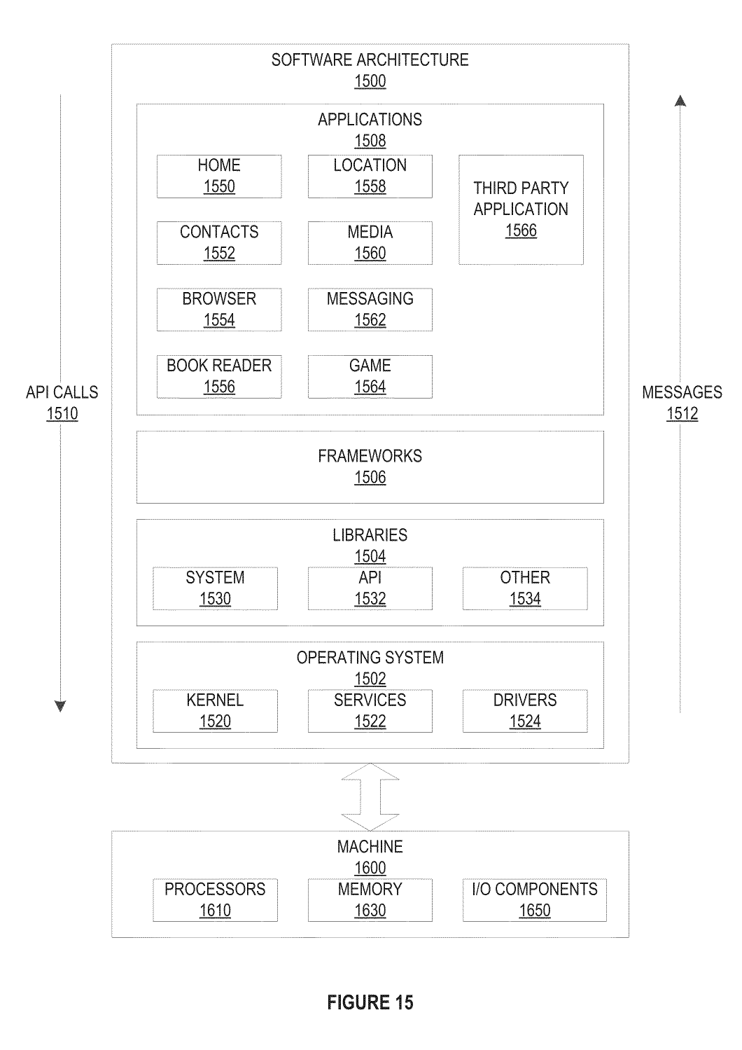

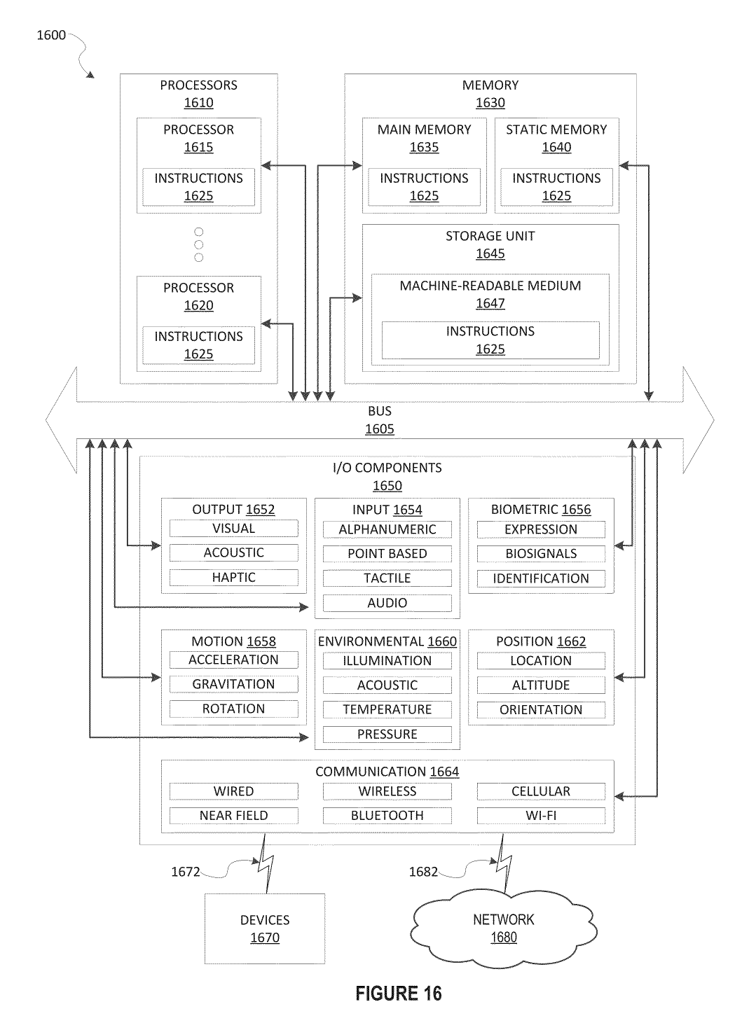

FIG. 15 is a block diagram illustrating an architecture of software 1500, in accordance with an example embodiment, which may be installed on any one or more of the devices of FIG. 1 (e.g., the server system 120 or client system 102 or merchant system 140). FIG. 15 is merely a non-limiting example of a software architecture and it will be appreciated that many other architectures may be implemented to facilitate the functionality described herein. The software 1500 may be executing on hardware such as a machine 1600 of FIG. 16, which includes processors 1610, memory 1630, and I/O components 1650. In the example architecture of FIG. 15, the software 1500 may be conceptualized as a stack of layers where each layer may provide particular functionality. For example, the software 1500 may include layers such as an operating system 1502, libraries 1504, frameworks 1506, and applications 1508. Operationally, the applications 1508 may invoke application programming interface (API) calls 1510 through the software stack and receive messages 1512 in response to the API calls 1510.

The operating system 1502 may manage hardware resources and provide common services. The operating system 1502 may include, for example, a kernel 1520, services 1522, and drivers 1524. The kernel 1520 may act as an abstraction layer between the hardware and the other software layers. For example, the kernel 1520 may be responsible for memory management, processor management (e.g., scheduling), component management, networking, security settings, and so on. The services 1522 may provide other common services for the other software layers. The drivers 1524 may be responsible for controlling and/or interfacing with the underlying hardware. For instance, the drivers 1524 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth.

The libraries 1504 may provide a low-level common infrastructure that may be utilized by the applications 1508. The libraries 1504 may include system libraries (e.g., C standard library) 1530 that may provide functions such as memory allocation functions, string manipulation functions, mathematic functions, and the like. In addition, the libraries 1504 may include API libraries 1532 such as media libraries (e.g., libraries to support presentation and manipulation of various media formats, such as MPEG4, H.264, MP3, AAC, AMR, JPG, or PNG), graphics libraries (e.g., an OpenGL framework that may be used to render 2D and 3D in a graphic content on a display 206), database libraries (e.g., SQLite that may provide various relational database functions), web libraries (e.g., WebKit that may provide web browsing functionality), and the like. The libraries 1504 may also include a wide variety of other libraries 1534 to provide many other APIs to the applications 1508.

The frameworks 1506 may provide a high-level common infrastructure that may be utilized by the applications 1508. For example, the frameworks 1506 may provide various graphic user interface (GUI) functions, high-level resource management, high-level location services, and so forth. The frameworks 1506 may provide a broad spectrum of other APIs that may be utilized by the applications 1508, some of which may be specific to a particular operating system 1502 or platform.

The applications 1508 include a home application 1550, a contacts application 1552, a browser application 1554, a book reader application 1556, a location application 1558, a media application 1560, a messaging application 1562, a game application 1564, and a broad assortment of other applications, such as a third party application 1566. In a specific example, the third party application 1566 (e.g., an application developed using the Android™ or iOS™ software development kit (SDK) by an entity other than the vendor of the particular platform) may be mobile software running on a mobile operating system such as iOS™, Android™, Windows® Phone, or other mobile operating systems. In this example, the third party application 1566 may invoke the API calls 1510 provided by the operating system 1502 to facilitate functionality described herein.

In some example embodiments, the encrypted electronic currency is an electronic form of sovereign currency that can be distributed to a portable electronic device. Thus the encrypted electronic currency is not a math-based crypto currency created by a math algorithm, but instead is a new electronic form of a sovereign currency. In some example embodiments, the server system (e.g., server system 120 in FIG. 1) controls the currency such that the currency is still under the control of the sovereign government that issues the physical currency.

In some example embodiments, the encrypted electronic currency is encrypted such that it replicate the anonymous feature of cash and thus the user cannot be tracked by the store, bank, or marketing organization.

In some example embodiments, the users can voluntarily allow certain information about transactions to be tracked by store, bank, or marketing organization.

### Example Machine Architecture and Machine-Readable Medium

FIG. 16 is a block diagram illustrating components of a machine 1600, according to some example embodiments, able to read instructions from a machine-readable medium (e.g., a machine-readable storage medium) and perform any one or more of the methodologies discussed herein. Specifically, FIG. 16 shows a diagrammatic representation of the machine 1600 in the example form of a computer system, within which instructions 1625 (e.g., software, a program, an application, an applet, an app, or other executable code for causing the machine 1600 to perform any one or more of the methodologies discussed herein) may be executed. In alternative embodiments, the machine 1600 operates as a stand-alone device or may be coupled (e.g., networked) to other machines. In a networked deployment, the machine 1600 may operate in the capacity of a server machine or a client machine in a server-client network environment, or as a peer machine in a peer-to-peer (or distributed) network environment. The machine 1600 may comprise, but be not limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine 1600 capable of executing the instructions 1625, sequentially or otherwise, that specify actions to be taken by the machine 1600. Further, while only a single machine 1600 is illustrated, the term “machine” shall also be taken to include a collection of machines 1600 that individually or jointly execute the instructions 1625 to perform any one or more of the methodologies discussed herein.

The machine 1600 may include processors 1610, memory 1630, and I/O components 1650, which may be configured to communicate with each other via a bus 1605. In an example embodiment, the processors 1610 (e.g., a central processing unit (CPU), a reduced instruction set computing (RISC) processor, a complex instruction set computing (CISC) processor, a graphics processing unit (GPU), a digital signal processor (DSP), an application specific integrated circuit (ASIC), a radio-frequency integrated circuit (RFIC), another processor, or any suitable combination thereof) may include, for example, a processor 1615 and a processor 1620 that may execute instructions 1625. The term “processor” is intended to include multi-core processors 1610 that may comprise two or more independent processors 1615, 1620 (also referred to as “cores”) that may execute instructions 1625 contemporaneously. Although FIG. 16 shows multiple processors 1615, 1620, the machine 1600 may include a single processor 1610 with a single core, a single processor 1610 with multiple cores (e.g., a multi-core processor), multiple processors 1610 with a single core, multiple processors 1610 with multiples cores, or any combination thereof.

The memory 1630 may include a main memory 1635, a static memory 1640, and a storage unit 1645 accessible to the processors 1610 via the bus 1605. The storage unit 1645 may include a machine-readable medium 1647 on which are stored the instructions 1625 embodying any one or more of the methodologies or functions described herein. The instructions 1625 may also reside, completely or at least partially, within the main memory 1635, within the static memory 1640, within at least one of the processors 1610 (e.g., within the processor's cache memory), or any suitable combination thereof, during execution thereof by the machine 1600. Accordingly, the main memory 1635, the static memory 1640, and the processors 1610 may be considered machine-readable media 1647.

As used herein, the term “memory” refers to a machine-readable medium 1647 able to store data temporarily or permanently, and may be taken to include, but not be limited to, random-access memory (RAM), read-only memory (ROM), buffer memory, flash memory, and cache memory. While the machine-readable medium 1647 is shown in, an example embodiment, to be a single medium, the term “machine-readable medium” should be taken to include a single medium or multiple media (e.g., a centralized or distributed database, or associated caches and servers) able to store instructions 1625. The term “machine-readable medium” shall also be taken to include any medium, or combination of multiple media, that is capable of storing instructions (e.g., the instructions 1625) for execution by a machine (e.g., the machine 1600), such that the instructions 1625, when executed by one or more processors of the machine (e.g., the processors 1610), cause the machine 1600 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory (e.g., flash memory), an optical medium, a magnetic medium, other non-volatile memory (e.g., erasable programmable read-only memory (EPROM)), or any suitable combination thereof. The term “machine-readable medium” specifically excludes non-statutory signals per se.

The I/O components 1650 may include a wide variety of components to receive input, provide and/or produce output, transmit information, exchange information, capture measurements, and so on. It will be appreciated that the I/O components 1650 may include many other components that are not shown in FIG. 16. In various example embodiments, the I/O components 1650 may include output components 1652 and/or input components 1654. The output components 1652 may include visual components (e.g., a display 206 such as a plasma display panel (PDP), a light emitting diode (LED) display, a liquid crystal display (LCD), a projector, or a cathode ray tube (CRT)), acoustic components (e.g., speakers), haptic components (e.g., a vibratory motor), other signal generators, and so forth. The input components 1654 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, and/or another pointing instrument), tactile input components (e.g., a physical button, a touch screen that provides location and force of touches or touch gestures, and/or other tactile input components), audio input components (e.g., a microphone), and the like.

In further example embodiments, the I/O components 1650 may include biometric components 1656, motion components 1658, environmental components 1660, and/or position components 1662, among a wide array of other components. For example, the biometric components 1656 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, finger print identification, or electroencephalogram based identification), and the like. The motion components 1658 may include acceleration sensor components (e.g., accelerometer), gravitation sensor components, rotation sensor components (e.g., gyroscope), and so forth. The environmental components 1660 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), and/or other components that may provide indications, measurements, and/or signals corresponding to a surrounding physical environment. The position components 1662 may include location sensor components (e.g., a Global Position System (GPS) receiver component), altitude sensor components (e.g., altimeters and/or barometers that detect air pressure, from which altitude may be derived), orientation sensor components (e.g., magnetometers), and the like.

Communication may be implemented using a wide variety of technologies. The I/O components 1650 may include communication components 1664 operable to couple the machine 1600 to a network 1680 and/or to devices 1670 via a coupling 1682 and a coupling 1672, respectively. For example, the communication components 1664 may include a network interface component or another suitable device to interface with the network 1680. In further examples, communication components 1664 may include wired communication components, wireless communication components, cellular communication components, near field communication (NFC) components, Bluetooth® components (e.g., Bluetooth® Low Energy), Wi-Fi® components, optical components, audio components, and other communication components to provide communication via other modalities, some of which may not yet be invented or in widespread use. The devices 1670 may be another machine 1600 and/or any of a wide variety of peripheral devices (e.g., a peripheral device coupled via a Universal Serial Bus (USB)).

Moreover, the communication components 1664 may detect identifiers and/or include components operable to detect identifiers. For example, the communication components 1664 may include radio frequency identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF48, Ultra Code, UCC RSS-2D bar code, and other optical codes), acoustic detection components (e.g., microphones to identify tagged audio signals), and so on. In additional, a variety of information may be derived via the communication components 1664, such as location via Internet Protocol (IP) geo-location, location via Wi-Fi® signal triangulation, location via detecting an NFC beacon signal that may indicate a particular location, and so forth.

### Transmission Medium

In various example embodiments, one or more portions of the network 1680 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 1680 or a portion of the network 1680 may include a wireless or cellular network and the coupling 1682 may be a Code Division Multiple Access (CDMA) connection, a Global System for Mobile communications (GSM) connection, or another type of cellular or wireless coupling. In this example, the coupling 1682 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 1625 may be transmitted and/or received over the network 1680 using a transmission medium via a network interface device (e.g., a network interface component included in the communication components 1664) and utilizing any one of a number of well-known transfer protocols (e.g., hypertext transfer protocol (HTTP)). Similarly, the instructions 1625 may be transmitted and/or received using a transmission medium via the coupling 1672 (e.g., a peer-to-peer coupling) to the devices 1670. The term “transmission medium” shall be taken to include any intangible medium that is capable of storing, encoding, or carrying the instructions 1625 for execution by the machine 1600, and includes digital or analog communications signals or other intangible media to facilitate communication of such software.

Furthermore, the machine-readable medium 1647 is non-transitory (in other words, not having any transitory signals) in that it does not embody a propagating signal. However, labeling the machine-readable medium 1647 “non-transitory” should not be construed to mean that the medium is incapable of movement; the medium should be considered as being transportable from one physical location to another. Additionally, since the machine-readable medium 1647 is tangible, the medium may be considered to be a machine-readable device.

### Term Usage

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

The foregoing description, for purpose of explanation, has been described with reference to specific embodiments. However, the illustrative discussions above are not intended to be exhaustive or to limit the possible embodiments to the precise forms disclosed. Many modifications and variations are possible in view of the above teachings. The embodiments were chosen and described in order to best explain the principles involved and their practical applications, to thereby enable others skilled in the art to best utilize the various embodiments with various modifications as are suited to the particular use contemplated.

It will also be understood that, although the terms “first,” “second,” etc. may be used herein to describe various elements, these elements should not be limited by these terms. These terms are only used to distinguish one element from another. For example, a “first contact” could be termed a “second contact,” and, similarly, a “second contact” could be termed a “first contact,” without departing from the scope of the present embodiments. The first contact and the second contact are both contacts, but they are not the same contact.

The terminology used in the description of the embodiments herein is for the purpose of describing particular embodiments only and is not intended to be limiting. As used in the description of the embodiments and the appended claims, the singular forms “a,” “an,” and “the” are intended to include the plural forms as well, unless the context clearly indicates otherwise. It will also be understood that the term “and/or”, as used herein, refers to and encompasses any and all possible combinations of one or more of the associated listed items. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context. Similarly, the phrase “if it is determined” or “if (a stated condition or event) is detected” may be construed to mean “upon determining (the stated condition or event)” or “in response to determining (the stated condition or event)” or “upon detecting (the stated condition or event)” or “in response to detecting (the stated condition or event),” depending on the context.

This written description uses examples to enable any person skilled in the art to practice the inventive subject matter, including making and using any devices or systems and performing any incorporated methods. Such other examples are intended to be within the scope of the claims if they have structural elements that do not differ from the literal language of the claims, or if they include equivalent structural elements with insubstantial differences from the literal languages of the claims.

What is claimed is:

1. A method comprising:
storing one or more encrypted electronic currency records in a database associated with a server system;
receiving one or more encrypted electronic currency units from a merchant system, wherein each of the one or more encrypted electronic currency units includes a unique identification value;
for each respective encrypted electronic currency unit of the one or more encrypted electronic currency units:
accessing a respective encrypted electronic currency record associated with the respective encrypted electronic currency unit;
determining, based on the encrypted electronic currency record associated with the respective encrypted electronic currency, whether the respective encrypted electronic currency unit is valid; and
in accordance with a determination that the respective encrypted electronic currency unit is valid, updating, by a processor associated with the server system, the respective encrypted electronic currency record to indicate that the encrypted electronic currency unit is no longer valid; and
in accordance with a determination that each encrypted electronic currency unit in the one or more encrypted electronic currency units are valid, transmitting a currency validation notification to the merchant system.

2. The method of claim 1, further comprising:
receiving, from a client system, a request for encrypted electronic currency units;
determining, based on user account data provided by the client system and also client data stored on the server system or elsewhere, whether the user associated with the client system is authorized to receive encrypted electronic currency units;
in accordance with a determination that the user associated with the client system is authorized to receive encrypted electronic currency units, generating one or more encrypted electronic currency units; and
transmitting the one or more generated encrypted electronic currency units to the requesting client system.

3. The method of claim 2, wherein the received request for funds includes a specified amount of encrypted electronic currency units.

4. The method of claim 2, wherein the received request for funds included a specified type of sovereign currency desired for the encrypted electronic currency units.

5. The method of claim 2, wherein determining, based on user account data stored for the client system, whether the user associated with the client system is authorized to receive encrypted electronic currency units, further comprising:
sending a withdrawal request to a specific financial institution system based on a user's account information;
determining whether the withdrawal request has been approved, and
in accordance with a determination that the request has been approved, receiving a specific amount of electronic funds from the financial institution system.

6. The method of claim 5, wherein the value of the generated one or more encrypted electronic currency units is equal to the value of the specific amount of electronic funds received from the financial institution system.

7. The method of claim 2, wherein generating an encrypted electronic currency unit includes selecting a random unique serial number as a unique identification value for the encrypted electronic currency unit.

8. The method of claim 2, further comprising, after generating an encrypted electronic currency unit, creating an encrypted electronic currency record for each generated encrypted electronic currency unit, wherein an encrypted electronic currency record includes at least all of the information for the encrypted electronic currency unit to which it corresponds and a currency validity field.

9. The method of claim 1, wherein accessing a respective encrypted electronic currency record associated with the respective encrypted electronic currency unit, further comprises:
determining the unique identification value for the respective encrypted electronic currency unit; and
identifying the encrypted electronic currency record with the same unique identification value.

10. The method of claim 1, wherein each encrypted electronic currency unit includes a value amount.

11. The method of claim 1, wherein each encrypted electronic currency unit includes a currency type.

12. The method of claim 1, wherein each encrypted electronic currency unit can only be used a single time and then is recorded as being invalid.

13. A server system comprising:
a storage module to store one or more encrypted electronic currency records in a database associated with a server system;
a reception module to receive one or more encrypted electronic currency units from a merchant system, wherein each of the one or more encrypted electronic currency units includes a unique identification value;
an encryption module to, for each respective encrypted electronic currency unit of the one or more encrypted electronic currency units:
access a respective encrypted electronic currency record associated with the respective encrypted electronic currency unit;
determine, based on the encrypted electronic currency record associated with the respective encrypted electronic currency, whether the respective encrypted electronic currency unit is valid; and
in accordance with a determination that the respective encrypted electronic currency unit is valid, update, by a processor associated with the server system, the respective encrypted electronic currency record to indicate that the encrypted electronic currency unit is no longer valid; and
a transmission module to, in accordance with a determination that each encrypted electronic currency unit in the one or more encrypted electronic currency units are valid; transmit a currency validation notification to the merchant system.

14. The system of claim 13, further comprising:
a request reception module to receive, from a client system, a request for encrypted electronic currency units;
a determination module to determine, based on user account data provided by the client system and also client data stored on the server system or elsewhere, whether the user associated with the client system is authorized to receive encrypted electronic currency units;
a generation module to, in accordance with a determination that the user associated with the client system is authorized to receive encrypted electronic currency units, generate one or more encrypted electronic currency units; and
a transmission module to transmit the one or more generated encrypted electronic currency units to the requesting client system.

15. The system of claim 14, wherein the received request for funds includes a specified amount of encrypted electronic currency units.

16. The system of claim 15, wherein the received request for funds included a specified type of sovereign currency desired for the encrypted electronic currency units.

17. A non-transitory computer-readable storage medium storing instructions that, when executed by the one or more processors of a machine, cause the machine to perform operations comprising:
storing one or more encrypted electronic currency records in a database associated with a server system;
receiving one or more encrypted electronic currency units from a merchant system, wherein each of the one or more encrypted electronic currency units includes a unique identification value;
for each respective encrypted electronic currency unit of the one or more encrypted electronic currency units:
accessing a respective encrypted electronic currency record associated with the respective encrypted electronic currency unit;
determining, based on the encrypted electronic currency record associated with the respective encrypted electronic currency, whether the respective encrypted electronic currency unit is valid; and
in accordance with a determination that the respective encrypted electronic currency unit is valid, updating, by a processor associated with the server system, the respective encrypted electronic currency record to indicate that the encrypted electronic currency unit is no longer valid; and
in accordance with a determination that each encrypted electronic currency unit in the one or more encrypted electronic currency units are valid; transmitting a currency validation notification to the merchant system.

18. The non-transitory computer-readable storage medium of claim 17, further comprising:
receiving, from a client system, a request for encrypted electronic currency units;
determining, based on user account data provided by the client system and also client data stored on the server system or elsewhere, whether the user associated with the client system is authorized to receive encrypted electronic currency units;
in accordance with a determination that the user associated with the client system is authorized to receive encrypted electronic currency units, generating one or more encrypted electronic currency units; and
transmitting the one or more generated encrypted electronic currency units to the requesting client system.

19. The non-transitory computer-readable storage medium of claim 18, wherein the received request for funds includes a specified amount of encrypted electronic currency units.

20. The non-transitory computer-readable storage medium of claim 18, wherein the received request for funds included a specified type of sovereign currency desired for the encrypted electronic currency units.
